(19) United States
(12) Patent Application Publication
(10) Pub. No.: US 2007/0220499 A1
(43) Pub. Date: Sep. 20, 2007

(54) USB tool stick with multiple processors

(75) Inventors: Ross Bannatyne, Austin, TX (US); Gautam Penumetcha, Austin, TX (US); Leonard Staller, Austin, TX (US); Phillip Bayes, College Station, TX (US); Douglas Holberg, Wimberly, TX (US)

Correspondence Address: HOWISON & ARNOTT, L.L.P, P.O. BOX 741715, DALLAS, TX, 75374-1715, US

(73) Assignee: SILICON LABORATORIES INC., AUSTIN, TX (US)

(21) Appl. No.: 11/538,046

(22) Filed: Oct. 2, 2006

Related U.S. Application Data
(63) Continuation-in-part of application No. 10/625,580, filed on Jul. 23, 2003.

(51) Int. Cl. G06F 9/45

(52) U.S. Cl. 717/140

(57) ABSTRACT

The present invention disclosed and claimed herein, in one aspect thereof, comprises a development system operating on a computer for evaluating compiled program code that was developed to run on a specific processor based functional IC having associated therewith memory and configurable data I/O modules, and which code defines the manner by which the functional IC will operate in a predetermined end application. An evaluation program is provided that is operable to run on the computer. A tool stick interfaces with the computer and includes a functional IC that is substantially operationally identical to the functional IC for which the compiled program code was developed to run on. The evaluation program is operable to interface with the tool stick to load the code in the functional IC associated with the tool stick and operable therewith such that the functional IC in the tool stick functions as a hardware emulator for the end application, such that the compiled code can be operated in hardware.

### CROSS-REFERENCE TO RELATED APPLICATIONS

This application is a Continuation-in-Part application of U.S. patent application Ser. No. 10/625,580 filed Jul. 23, 2003, and entitled “USB INTEGRATED MODULE,” (ATTY. Dkt. No. CYGL-26,370), and is related to U.S. Pat. No. 6,968,472, issued Nov. 22, 2005 (Atty. Dkt. No. CYGL-25,987) and pending U.S. patent application Ser. No. 10/244,728, filed Sep. 16, 2002, entitled “CLOCK RECOVERY METHOD FOR BURSTY COMMUNICATIONS,” all of which are incorporated herein by reference.

### TECHNICAL FIELD OF THE INVENTION

The present invention pertains in general to a Universal Serial Bus (USB) serial data interface and, more particularly, to a modularized USB interface.

### BACKGROUND OF THE INVENTION

Integrated Systems on a Chip (SOC) have seen increasing use in that these type of integrated circuits typically provide a monolithic solution that incorporates on chip a processing unit and multiple peripheral functional blocks, one of which typically includes some type of analog data converter such as an analog-to-digital converter and/or a digital-to-analog converter. This typically results in a mixed signal integrated circuit. These chips are typically referred to as microcontroller units (MCU). These MCUs are becoming increasingly more complex and include thereon large imbedded flash memory, high speed processors and high resolution data converters.

In order to utilize these systems, they must be configured, since they utilize an instruction based engine which requires a program to be loaded therein. Further, there are included on these MCUs a plurality of different configuration registers, different functional hardware that comprises the physical layer for the data I/OI\O. All of this can be configured either initially or through the program. Thus, the flash memory is utilized to store an initial configuration that defines the nature of the application. For example, the MCU may be utilized in a motor control application, which requires the program to operate in a certain manner, the pins on the package to be configured in a certain manner to receive digital data on some pins and analog data on the other pins, different sampling algorithms for sampling analog inputs, etc. All of this information must be developed in a program by a system's developer and then downloaded into the part. Typically, there will be provided some type of developer kit that will allow a system's developer to develop the entire code associated with the application for download to the part and will provide some type of emulation program to debug the code. Additionally, once the code is downloaded into the part, the part can then be placed into an emulation board and a debug port on the part can be utilized to step through the program to possibly debug the program. However, all of these tools are required in order to allow a system's developer to more easily implement the MCU into a final application. Further, many of the parameters of the code can be changed.

One of the difficulties with utilizing these various development kits that are provided by manufacturers of MCUs is that they are not very user friendly and typically require some type of software development tool, and an emulation board, wherein the code is first generated, compiled as source code, and then downloaded to the part and then the part disposed on an emulator board. However, this still presents some difficulties in actually ensuring that the part works correctly. Further, it is still somewhat difficult for a user to determine if the part is working correctly. During the development stage, usually some type of emulation is required, such as a software emulator that emulates the chip on which the code is to rum. These are expensive to create and, with so many different configurations for the end chip hardware configuration, numerous emulated chip would be required. Therefore, there still exists a need for more enhanced development tools for not only developing the application software and compiling it as source code, but also modifying that code in an actual part that is disposed in its operating environment.

### SUMMARY OF THE INVENTION

The present invention disclosed and claimed herein, in one aspect thereof, comprises a development system operating on a computer for evaluating compiled program code that was developed to run on a specific processor based functional IC having associated therewith memory and configurable data I/O modules, and which code defines the manner by which the functional IC will operate in a predetermined end application. An evaluation program is provided that is operable to run on the computer. A tool stick interfaces with the computer and includes a functional IC that is substantially operationally identical to the functional IC for which the compiled program code was developed to run on. The evaluation program is operable to interface with the tool stick to load the code in the functional IC associated with the tool stick and operable therewith such that the functional IC in the tool stick functions as a hardware emulator for the end application, such that the compiled code can be operated in hardware.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an overall diagrammatic view of the USB module;

FIG. 2 illustrates an alternate embodiment of the USB module;

FIG. 3 illustrates an overall block diagram of a mixed-signal integrated circuit utilizing a USB port;

FIG. 4 illustrates a more detailed diagram of the integrated circuit of FIG. 3;

FIGS. 5 & 6 illustrate cross-sectional views of the USB module shown in different configurations of how the processor chip is interfaced with the USB connecter;

FIG. 7 illustrates an overall diagrammatic view of the system of the present disclosure;

FIG. 8 illustrates a diagrammatic view of the integrated circuit with the serial interface disposed thereon;

FIG. 9 illustrates a more detailed diagram of the embodiment of FIG. 8;

FIG. 10 illustrates a detailed diagram of the serial interface controller;

FIG. 11 illustrates a timing diagram for the AddressWrite timing;

FIG. 12 illustrates a timing diagram for the AddressRead timing;

FIG. 13 illustrates a timing diagram for a device reset;

FIG. 14 illustrates the bit sequence of an AddressWrite instruction;

FIG. 15 illustrates the bit sequence of an AddressRead instruction;

FIG. 16 illustrates the bit sequence for a DataWrite instruction;

FIG. 17 illustrates the bit sequence for the DataRead instruction;

FIG. 18 illustrates a schematic diagram for the external interface to the serial interface pins;

FIG. 19 illustrates a timing diagram for the device halt;

FIG. 20 illustrates a flowchart of the AutoHalt feature;

FIG. 21 illustrates a diagrammatic view of the TestMode operation;

FIG. 22 illustrates a timing diagram for the TestMode operation;

FIG. 23 illustrates an interface to a clock pin from a parallel port; and

FIG. 24 illustrates a flowchart for the operation of receiving and processing a ReadAddress command;

FIG. 25 illustrates a diagrammatic view of the two state machines;

FIG. 26 illustrates a diagrammatic view of the translator 706;

FIG. 27a illustrates a flowchart depicting the operation of an AddressWrite command on the translator;

FIG. 27b illustrates a diagrammatic view of the manner in which the data registers interface with the integrated circuit; and

FIG. 28 illustrates a side view of the tool stick illustrating the functional CPU and peripheral disposed within the tool stick itself;

FIG. 29 illustrates a diagrammatic view of the attachment of the tool stick to a PC;

FIG. 30 illustrates an alternate embodiment wherein current flow and voltage flow is illustrated;

FIG. 31 illustrates a perspective view of a tool stick with a removable functional CPU module such that the functional CPU module can be changed;

FIG. 32 illustrates a diagrammatic view of the embodiment of FIG. 31 illustrating multiple functional modules being attached to the overall tool stick;

FIG. 33 illustrates an embodiment where the functional CPU is disposed in the casing and an external peripheral controlled device is exposed external thereto and attachable thereto with a connector;

FIG. 34 illustrates a diagrammatic view of the embodiment of FIG. 33;

FIG. 35 illustrates a diagrammatic view of the GUI application operating at the injunction with a PC;

FIGS. 36 and 37 illustrate screen shots for the Integrated Development Environment (IDE) tool that operates on the PC; and FIGS. 38-43 illustrate screen shots for the code configuration wizard for generating the configuration value for the part.

### DETAILED DESCRIPTION OF THE INVENTION

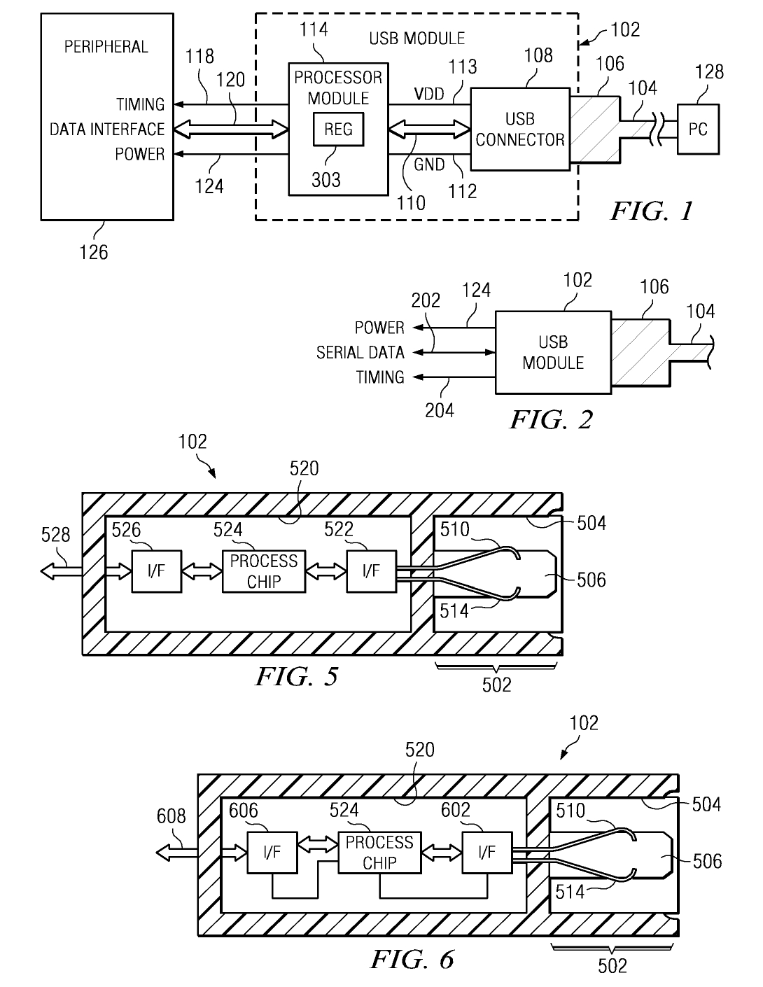

Referring now to FIG. 1, there is illustrated a block diagram of a USB module 102 connected to a peripheral 126 to form the tool stick, the USB module providing an interface between a USB cable 104 that has associated therewith a female USB connector 106 and the peripheral 126. The USB module 102 contains thereon a male USB connector 108 that is operable to provide a receptacle for receiving the USB connector 106. The USB connector 108 has a number of different configurations that are standardized. They can be an A-type receptacle, a B-type receptacle and the mini-B receptacle or the mini-A receptacle, in addition to the mini A-B receptacle. These are all standard configurations. As will be described herein below, in general, each of the USB connectors provides a positive supply connector, a ground connector, a data connector, a data line and a clock line. The cable 104 provides power to the USB connector, and data and clock information is output from the USB connector 108 on a data/clock bus 110, it being understood that there is typically only a single data line for data transmission in any one direction of serial data, and only one clock line is needed. There is provided a ground line 112 and a power supply line 113. Typically, the current provided on power supply line 113 is limited to around 500 milliamps.

The data/clock information on bus 110 and the ground and power supply on lines 112 and 113 are all provided to a processor module 114. The processor module 114, as will be described in more detail herein below, is operable to be powered by the power supply line 114 to process the data received in the USB format in accordance with various process algorithms associated with the processor module 114. This processor module 114 utilizes the functionality of part no. C8051F32X, which is manufactured by Silicon Laboratories Inc. This processor module 114 is operable to provide an interface between a serial port on the peripheral module 126 and the USB connector 108 to allow data to be transmitted from a PC 128 to the peripheral module 126 for downloading of application program code, data input, etc., and receiving at the PC 128 data from the peripheral module 126. This data reception is typically in response to a memory read where the contents of a Special Function Register (SFR) are retrieved, as will be described in more detail hereinbelow. The timing information from the processor module 114 can be provided on a timing interface 118 outside of the module 102 and data can be provided to a data interface 120 from processor module 114. Power is provided to the processor module 114 through the line 113 and an internal regulator regulates this to a lower level, as USB power is typically 5.0 Volts and the power associated with a peripheral can be lower. This regulated power is provided on a line 124.

Referring now to FIG. 2, there is illustrated a diagrammatic view of one example of the use of the USB module 102 and the serial data interface. The USB module 102 in FIG. 2 is configured to provide a serial data bus interface. Thus, the data interface exterior to the module 102 will be a serial data string on a serial data line 202 that can transmit data and/or receive data. This could be a transmit only configuration, a receive only configuration or a bi-directional configuration. In addition, timing information can be provided on a timing clock line 204. Such serial data protocols as I²C, as one example, require both data and timing. Such a data interface is illustrated in U.S. Pat. No. 4,689,740. Further, there are Serial Data Interfaces that do not require timing, one such interface described in U.S. Pat. No. 5,210,846, which are both incorporated herein by reference. Further, other types of asynchronous serial data formats that do not require timing but require clock recovery are those such as Manchester coded PSK. These, of course, only require a single data line. One such data interface is illustrated in U.S. Pat. No. 4,621,190. However, the preferred embodiment will use a proprietary serial data interface, as will be described herein below. This is the “C2” interface, a serial clocked data interface. Alternately, a JTAG interface could be utilized. These interfaces are utilized in the tool stick to allow a system developer to download compiled application code to the peripheral 126, and then retrieve information from select memory locations therein.

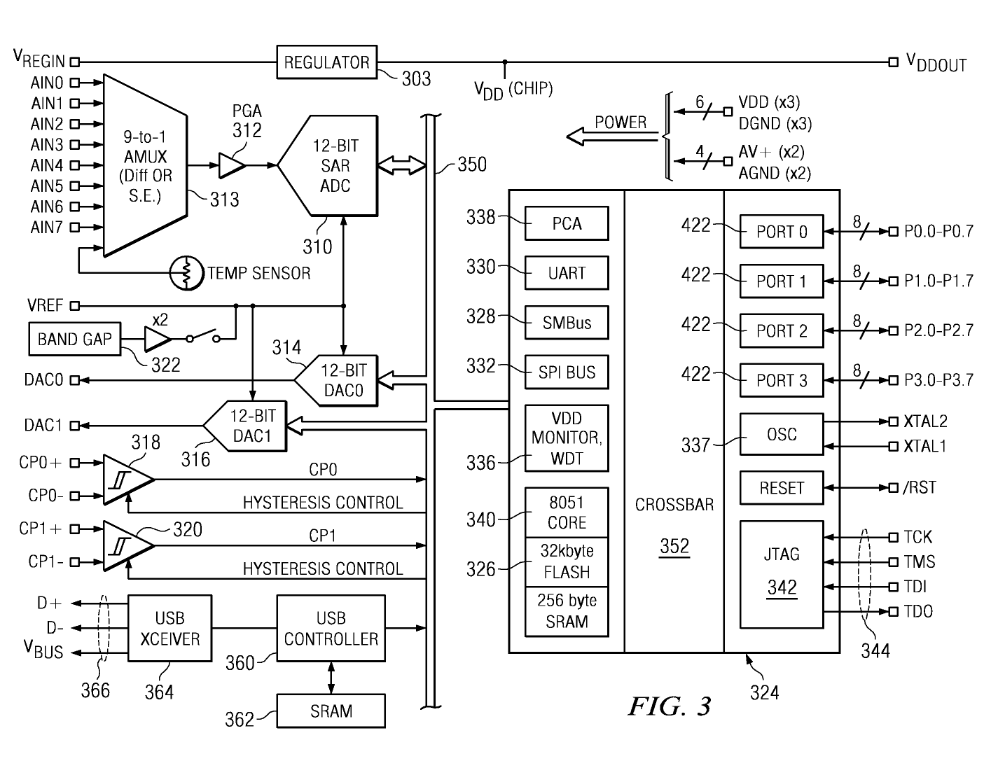

Referring now to FIG. 3, there is illustrated an integrated circuit that provides the functionality of the processor module 114, that is comprised of a fully integrated mixed-signal System on a Chip with a true 12-bit multi-channel ADC 310 with a programmable gain pre-amplifier s12, two 12-bit DACs 314 and 316, two voltage comparators 318 and 320, a voltage reference 22, and an 8051-compatible microcontroller core 324 with 32 kbytes of FLASH memory 326. There is also provided an I2C/SMBUS 328, a UART 330, and an SPI 332 serial interface 340 implemented in hardware (not “bit-banged” in user software) as well as a Programmable Counter/Timer Array (PCA) 334 with five capture/compare modules. There are also 32 general purpose digital Port I/Os. The analog side further includes a multiplexer 313 as operable to interface eight analog inputs to the programmable amplifier 312 and to the ADC 310. An on-chip regulator 303 is provided that will provide regulated power to the chip and a regulated power output for powering the peripheral module 126.

With an on-board V_{DD} monitor 336, WDT, and clock oscillator 337, the integrated circuit is a stand-alone System on a Chip. The MCU effectively configures and manages the analog and digital peripherals. The FLASH memory 326 can be reprogrammed in-circuit, providing non-volatile data storage, and also allowing field upgrades of the 8051 firmware. The MCU can also individually shut down any or all of the peripherals to conserve power.

A JTAG interface 342 allows the user to interface with the integrated circuit through a conventional set of JTAG inputs 344. On-board JTAG debug support allows non-intrusive (uses no on-chip resources), full speed, in-circuit debug using the production integrated circuit installed in the final application. This debug system supports inspection and modification of memory and registers, setting breakpoints, watch points, single stepping, run and halt commands. All analog and digital peripherals are fully functional when debugging using JTAG.

The microcontroller 340 is fully compatible with the MCS-51™ instruction set. Standard 803x/805x assemblers and compilers can be used to develop software. The core has all the peripherals included with a standard 8051, including three 16-bit counter/timers, a full-duplex UART, 656 bytes of internal RAM, 128 byte Special Function Register (SFR) address space, and four byte-wide I/O Ports. A Universal Serial Bus (USB) interface is provided with a controller 360 that interfaces with memory 362 (of which all or a portion may be on the integrated circuit with the controller 360) and a USB transceiver 364. The transceiver 364 will interface with dedicated pins 366 to receive/transmit serial data. This data is referred to as “bursty communications.”

Referring further to FIG. 3, the core 340 is interfaced through an internal BUS 350 to the various input/output blocks. A cross-bar switch 352 provides an interface between the UART 330, SPI BUS 332, etc., and the digital I/O output. This is a configurable interface.

The core 340 employs a pipelined architecture that greatly increases its instruction throughput over the standard 8051 architecture. In a standard 8051, all instructions except for MUL and DIV take 12 or 24 system clock cycles to execute with a maximum system clock of 12 MHz. By contrast, the core 340 executes seventy percent (70%) of its instructions in one or two system clock cycles, with only four instructions taking more than four system clock cycles. The core 340 has a total of 509 instructions. The number of instructions versus the system clock cycles to execute them is as follows:

| | Instructions | | | | | | | | |
|---|---|---|---|---|---|---|---|---|---|
| | 26 | 50 | 5 | 14 | 7 | 3 | 1 | 2 | 1 |
| Clocks to Execute | 1 | 2 | 2/3 | 3 | 3/4 | 4 | 4/5 | 5 | 8 |

With the core 540's maximum system clock at 20 MHz, it has a peak throughput of 20MIPS.

As an overview to the system of FIG. 3, the cross-bar switch 352 can be configured to interface any of the ports of the I/O side thereof to any of the functional blocks 328, 330, 332, 334 or 336 which provide interface between the cross-bar switch 352 and the core 340. Further, the cross-bar switch can also interface through these functional blocks 328-336 directly to the BUS 350.

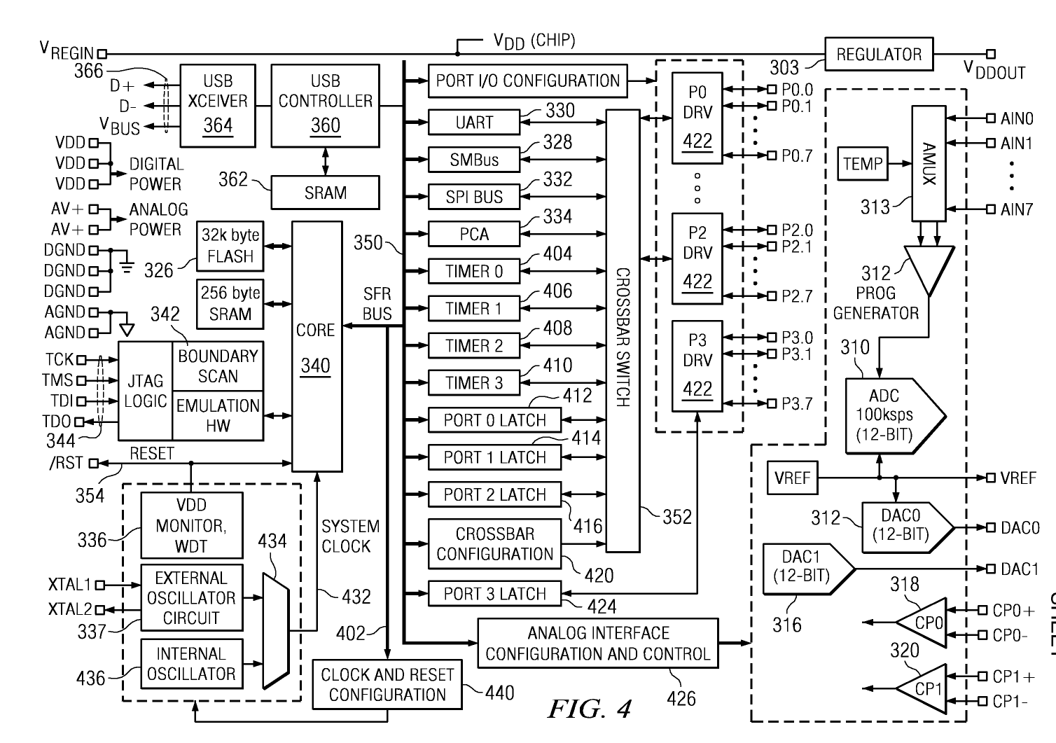

Referring now to FIG. 4, there is illustrated a more detailed block diagram of the integrated circuit FIG. 3. In this embodiment, it can be seen that the cross-bar switch 352 actually interfaces to a system BUS 402 through the BUS 350. The BUS 350 is operable to allow core 340 to interface with the various functional blocks 328-334 in addition to a plurality of timers 404, 406, 408 and 410, in addition to three latches 412, 414 and 416. The cross-bar switch 352 is configured with a configuration block 420 that is configured by the core 340. The other side of the cross-bar switch 352, the I/O side, is interfaced with various port drivers 422, which is controlled by a port latch 424 that interfaces with the BUS 350. In addition, the core 340 is operable to configure the analog side with an analog interface configuration in control block 426.

The core 340 is controlled by a clock on a line 432. The clock is selected from, as illustrated, one of two locations with a multiplexer 434. The first is external oscillator circuit 337 and the second is an internal oscillator 436. The internal oscillator circuit 436 is a precision temperature compensated oscillator, as will be described herein below. The core 340 is also controlled by a reset input on a reset line 354. The reset signal is also generated by the watchdog timer (WDT) circuit 336, the clock and reset circuitry all controlled by clock and reset configuration block 440, which is controlled by the core 340. Therefore, it can be seen that the user can configure the system to operate with an external crystal oscillator or an internal precision non-crystal non-stabilized oscillator that is basically “free-running.” This oscillator 436, as will be described herein below, generates the timing for both the core 340 and for the UART 330 timing and is stable over temperature.

The description of the precision oscillator 436 is described in U.S. patent application Ser. No. 10/244,728, filed Sep. 16, 2002 and entitled “CLOCK RECOVERY METHOD FOR BURSTY COMMUNICATIONS” (Atty. Docket No. CYGL-26,068), which is incorporated by reference in its entirety.

The processor housing portion of each of the modules noted herein utilizes a processor that can interface with an asynchronous data protocol such as a USB data protocol without requiring a crystal. This is due to the fact that the processor has disposed thereon a precision oscillator that can track a frequency close enough that it does not require a crystal time base. By not requiring a crystal time base, a much more compact configuration can be provided.

Referring now to FIG. 5, there is illustrated a cross-sectional view of the USB module 102. In one embodiment, the module includes a USB connector region 502 which is of a conventional configuration. In the conventional configuration, there is provided a cavity 504 within which is disposed a protrusion member 506. This is the support member for supporting the conductive pins, of which two are shown, pins 510 and 514, disposed on opposite sides of the protrusion 506. Since they are shown in the side view, it should be understood that there are multiple pins or contacts on either side of the protrusion 506, depending upon the configuration and the style of pin. As it is noted that there are a number of different pin configurations depending upon whether the USB connector is an A-type connector or a B-type connector or whether it is a “mini” version thereof. In general, however, the minimum pin count required is a ground, a positive supply voltage and a data line.

The pins 510 and 514 extend into a processor cavity portion 520, which contains an interface 522 that interfaces between the pins 510 and 514 (noting that only two pins are shown, although there are more) and a processor chip 524, which contains the functionality of the processor module 114. The processor chip 524 is then interfaced through an interface block 526 with an interface bus 528 exterior to the processor cavity 520. It is noted that the processor chip 524 is powered by power provided to the USB connector portion 502, this power converted through the interface 522. The interface 526 can now input data, receive data and output power.

Referring now to FIG. 6, there is illustrated an alternate embodiment of the embodiment of FIG. 5. In this embodiment, there is provided an interface 602 that interfaces data and power to the processor chip 524 and also interfaces power to an interface 606 that is operable to interface data from the processor chip 524 to an external interface bus 608 and also interface power to the interface 606 from a regulator on the processor chip 524, such that the interface 606 can utilize the power for the internal operations thereof or can interface the power external to the USB module 102.

Serial Data Interface

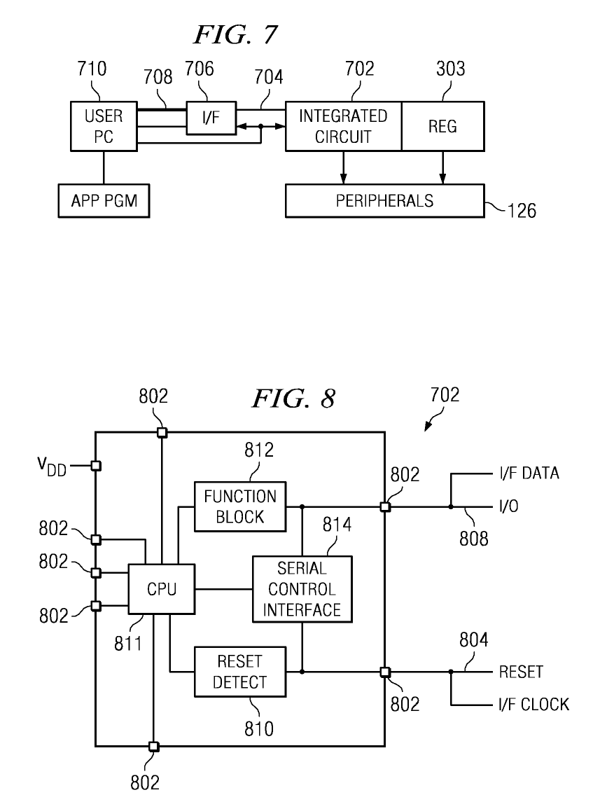

Referring now to FIG. 7, there is illustrated a diagrammatic view one example of the peripheral device 126, an integrated circuit 702 having associated therewith interface circuitry for interfacing one or more pins thereof to a serial data bus 704, either one or two wires through a mapping interface block 706—a translator 706, this being a general reference to the USB processor chip 114 of FIG. 1. This is described in U.S. Pat. No. 6,968,472, which is incorporated herein by reference. The translator 706 is operable to map a conventional data protocol from a data bus 708 that interfaces with a user PC 710 to the serial data bus 704. The bus 708 can be either a serial data bus such as a USB data bus or parallel port. The serial data bus 704 is bi-directional and can be synchronous or asynchronous. In the first disclosed embodiment, this is a synchronous data bus. This serial data bus allows the processor module 114 to interface with the peripheral 126 of FIG. 1

Referring now to FIG. 8, there is illustrated a diagrammatic view of one embodiment of the present disclosure. The integrated circuit 702 is illustrated as having multiple pins 802 associated therewith, two of which are associated with the serial data interface. In this exemplary disclosure, one of the pins 802 is associated with a reset function in the normal operating mode and is connected to a reset signal on an external line 804, and a second pin 802 is associated with some type of input/output function in the normal operating mode, this being a bi-directional or a uni-directional pin. This is connected to an I/O output line 808. The reset pin in normal operating mode is connected to a reset detect circuit 810 which, when the reset line 804 goes low for a predetermined amount of time, will cause a device reset to be transmitted to an internal CPU 811 (and various other blocks that may require reset—not shown). The CPU 811 runs the general functions on the integrated circuit 702, it being understood that many functions can be represented in this block, such as analog-to-digital converters, digital-to-analog converters, multiplex functions, internal data storage in the form of non-volatile memory and volatile memory, and many more functions. The CPU 811 is illustrated as interfacing with all of the pins 802 in some form with the one pin associated with the output line 808 having associated therewith a function block 812. This function block 812 illustrates that this may be a driver or a receiver. It should be understood that each of the other pins would have some type of buffer circuit of some sort associated therewith, although not illustrated for simplicity purposes.

The pin associated with the reset detect circuit 810 and the pin associated with the function block 812 are multi-function or shared pins that operate in the normal operating mode with one functionality and in a serial data transfer mode with a second functionality. The pin associated with the function block 812 is shared with the serial interface data function, and the pin 802 associated with the reset detect circuit 812 and the reset function is shared with the serial interface timing or clock information from the serial data. A serial control interface 814 is provided for interfacing with the pin 802 associated with function block 812 and the pin 802 associated with the reset detect circuit 810 in order to receive the serial data and the serial clock and interface with the CPU 811. As will be described in more detail hereinbelow, in normal operation, the CPU 811 operates on its own clock whereas the control interface 814 operates on the serial clock received on the pin 802 associated with the reset function. As will also be described hereinbelow, the interface in the disclosed embodiment operates by detecting the presence of a serial clock signal on the reset pin and then taking possession (“stealing”) of the data pin associated with the output I/O function 808 in order to receive/transmit serial data. However, the “stealing” of the data pin can be triggered by a signal other than the serial clock and on any other pin, even including the shared data pin. Further, a serial clock signal would not be required for an asynchronous protocol.

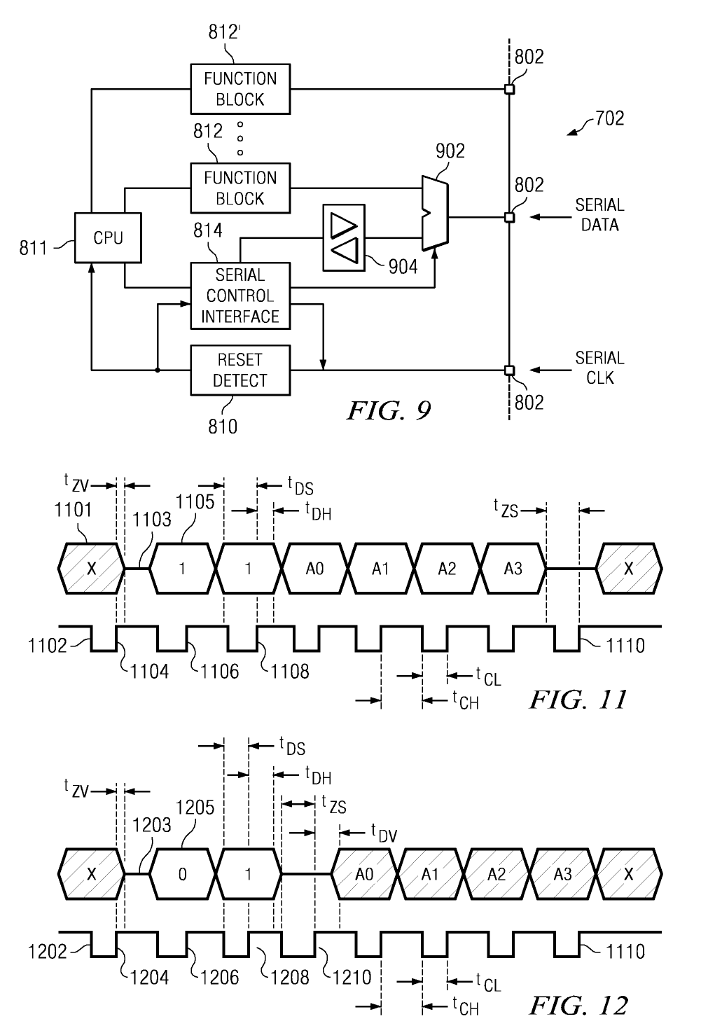

Referring now to FIG. 9, there is illustrated a more detailed diagram of the serial data interface on the integrated circuit 802. As noted hereinabove, the function block 812 associated with the one pin 802 that shares its function with that of the serial data, the “shared” data pin, there are also provided similar function blocks 812′ associated with other of the pins 802. To enable sharing of the data pin, a multiplexer 902 is provided having two multiplexed input/outputs, one input/output associated with the function block 812 and one associated with a data transceiver 904, and another unmultiplexed input/output associated with the pin 802 and connected thereto. The multiplexer 902 is operable to connect the pin 802 either to the function block 812 or the transceiver 904, this controlled by a control interface 814. When the multiplexer 902 is interfaced to the transceiver 904, this is referred to as “stealing” or possessing the functionality of the pin 802 that was initially associated with function block 812.

In the present disclosure, there is illustrated only a single multiplexer 902 associated with a single block 802. In the serial data mode, the initiation thereof is provided by pulling the reset pin low for a short duration of time and then high, the duration being less than that for the reset operation, as will be described in more detail hereinbelow. This is recognized by the serial interface controller 814 as a “start bit.” When this occurs, the system is preconfigured to select only one pin as a serial data pin, in this embodiment. However, it could be that more than one pin were selected to allow writing of more than one bit at a time, i.e., there could be a two bit input, or there could be an eight bit input for receiving eight bits at a time. However, in the present disclosure, it is only a single bit. Further, the system could be originally configured such that more than one pin had a multiplexer 902 associated therewith. A preconfigured register could assign any one of the pins as a serial data input. However, this would have to be preconfigured such that the serial interface controller 814 would know which multiplexer or which pin to possess during the serial data mode.

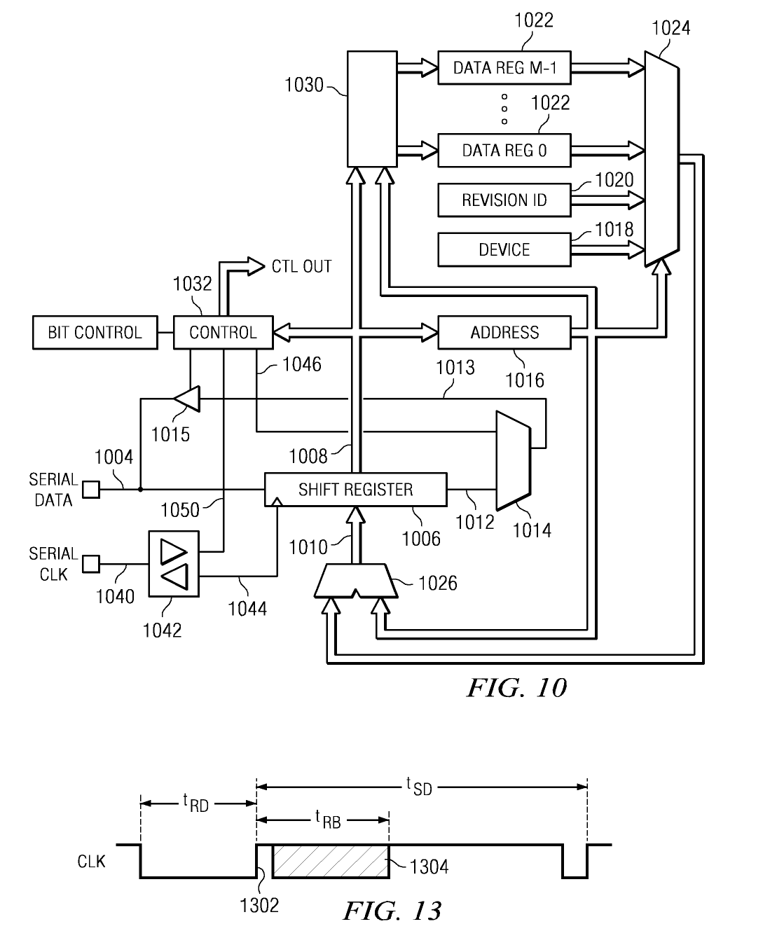

Referring now to FIG. 10, there is illustrated a more detailed diagram of the serial interface controller 814. In general, the serial interface controller is similar to a JTAG interface wherein the TMS, TDI and TDO functions have all been mapped onto a single bi-directional push-pull data pin. The JTAG interface typically requires four pins, one for data in, one for data out, one for clock and one for state machine control. In the present disclosure, all data is transmitted and received LSB first. The direction of the data is specified by the instruction protocol, such that contention between the device and the interface master is never allowed. The serial data is received on a pin 1004 and input to a shift register 1006. The shift register 1006 is a serial-parallel-serial data register that can sample or drive the data pin 1004. For input of data, data is input thereto, converted to parallel data and the parallel data output onto a data bus 1008. For output of data, parallel data is received by shift register 1006 from a data bus 1010 and output on a serial data line 1012 to one input of a multiplexer 1014 to a serial data line 1013. Serial data line 1013 is input to a gated driver 1015 for output to the serial line 1004.

The serial clock is received on a serial clock line 1040 and interfaced to a bi-directional driver block 1042. When the clock is being received, i.e., the line is being pulled low and then transitioned high, a clock signal will be output on a line 1044 to the clock input of the shift register 1006. However, a control block 1032 that controls the overall operation of the system, which will be described in more detail hereinbelow, has the option of forcing the line 1040 low to provide status signals to the translator 706 via the serial clock line 1040. Further, the controller 1032 also has the option of forcing the data line high with the multiplexer 1014 by placing a “1” (this could also be “0” in some other type of application) on a line 1046 input to the other input of multiplexer 1014 that is connected to the line 1013. The controller 1032, when sending a signal to the external system via the serial clock line 1040, will generate a pull-down signal on a line 1050. This will be described in more detail hereinbelow.

The serial interface controller 814 provides access to on-chip programming, tests, and debug logic through a set of registers that consist of an address register 1016, a device ID register 1018, a revision ID register 1020 and a plurality of data registers 1022, there being M of these registers. These registers represent an input to any function on the integrated circuit 702. For example, the register could be an input register to Flash memory or a register setting a flag. By loading select ones of these registers, the integrated circuit can be initialized, such that an initial set of configuration data is loaded that will be accessed upon a device reset.

Each of the data registers 1022 and the address register 1016 are illustrated as having an input thereof connected to the output of a decode block 1030, which selects one of the data registers 1022 for writing of information thereto. The input of the decode block 1030 is connected to the bus 1008, the ID register 1020 and the device ID register 1018 being read-only registers with no input. Each of the registers 1018-1022 have the output thereof input to a multiplexer 1024 which is addressable by the output of the address register 1016. Therefore, an address can be loaded into the address register 1016, which will select, during a AddressRead command, the output of one of the registers 1018-1022. The output of the multiplexer 1024 is input to one input of a two input multiplexer 1026, the other input thereof connected to the output of the address register 1016. Therefore, either the contents of the address register can be read by itself or the contents of one of the addressed other registers can be read. During a Write operation, the address register 1016 is first written and then this address selects one of the data registers 1022 with a decode block 1030.

The overall operation is controlled with a central controller 1032 that provides control outputs to the various multiplexers and the such. The controller 1032 contains all of the serial interface protocol that provides access to all of the interface registers, plus reset and wait state capabilities. The address register 1016 in general defines which data register will be accessed during subsequent data instructions, whereas the device ID register provides an eight-bit device ID that must be read in order to determine certain aspects about the device. The revision ID register provides an eight-bit revision ID that can be read and utilized to determine information about the configuration of the device, this configuration being hard coded into the integrated circuit 702. The data contained in the data registers 1022 is associated with device-specific functions.

Although the data registers 1022 are illustrated as having the ability to be both written to and read from, this is not necessarily required for all functions. A data register can be defined as a read-only register or it can return an undefined value when read. Also, the data register can be written with a single value but return another value. For example, a data register may serve as a control register when written but return status information when read. This also applies to the address register 1016.

From a timing standpoint, all data that is received on the serial pin 1004 is timed relative to rising edges of the serial clock. The device both samples data on the serial line 1004 and changes its output values on rising edges of the serial clock. The bit timing is designed such that the state of the serial data line can remain constant when the serial clock line is low. This simplifies the serial data timing and allows the interface to be “bit-banged” using a PC parallel port with the addition of a simple one-shot circuit, as will be described in more detail hereinbelow. The general timing allows the serial data pin to maintain its user-defined state between interface instructions. When a start bit of a serial data instruction is received, it forces the shared data pin as an input to the serial data operation. During normal operation in the user-defined state (non-serial data operation), the actual value of the start bit is ignored by the interface logic. After the start bit, the translator 706 then enables its data driver in order to transmit appropriate instruction bits. The controller 1032 is enabled to examine the first two bits, in this disclosed embodiment, as instruction bits. Of course, this defines only four instructions, whereas more bits could be associated with the instructions to incorporate more instructions into the system. As will be described hereinbelow, Write instructions end with a stop bit similar to the start bit, whereas Read instructions do not use a stop bit.

Referring now to FIG. 11, there is illustrated a timing diagram for the AddressWrite command. This example illustrates a Write operation to a four-bit address register. The instruction begins with a start bit when the reset line initially goes low, at a transition 1102, where the function block 812 is active in the normal operating mode, such that the serial data pin is under control of the CPU 811. However, when the next transition 1104 occurs, this occurring before the reset time of the reset detect block 810, this indicates that the serial mode is being initiated. If it were a Reset operation, typically, the time between a negative going transition and a positive going transition must be greater than five or ten μs. However, if it is less than that, then this indicates a start bit. Therefore, the start bit indicates that the possession of the data pin should be directed to the serial interface controller 814 and taken away from the CPU 811 and function block 812. The shaded areas on the data indicate the data line is being driven by either the serial interface circuitry on the integrated circuit 702 or other circuitry on the integrated circuit 702 and non-shaded areas indicate driving by the translator 706. After the transition 1104, the translator 706 will enable its output driver.

In the diagram, the box 1101 indicates that the function block 812 has possession of the pin, whereas the translator 706 tri-states its driver. At edge 1104, the driver associated with translator 706 is enabled, which has some delay associated therewith, resulting in the output of the translator driver being tri-stated, indicated by a state 1103. This is where possession of the pin is transferred or “stolen,” indicated by a time period t_{zv} of approximately 1 to 20 ns. This will result in data being output in a data valid field 1105 for the first command bit at the end of state 1103. This data will then be output by the translator 706 and will be shifted in at the next rising edge, edge 1106, to shift in an instruction bit, a “1” bit, and then another and subsequent data bit will be shifted in at the following and second rising transition 1108 to shift in another instruction bit, a “1” bit. For an AddressWrite command, the control word is a “11” that is read by the controller 1032, which controller 1032 is operable to recognize the first two bits shifted in as the appropriate command to determine whether this is a Read or a Write operation. Once it recognizes the first two bits as being a “11,” it then knows to look for follow-on bits as the address information. It should be understood that the reason that only four bits are associated with the address is that a previous reading of the device ID register 1018 indicated the length of the address register to be four bits. The next four rising edges will shift into four address bits which will then, after shifting therein, be loaded into the address register 1016. After shifting in of the last of the four address bits, the translator 706 will tri-state its output at a state 1109, and then a rising transition 1110 will denote the end of the stop bit and will change the state of the multiplexer 902 in order to allow functionality to be returned to the CPU 811 in the function block 812.

Referring now to FIG. 12, there is illustrated a timing diagram for the AddressRead command. In this example, a four bit address will be read from the address register 1016. As was the case with the Write timing, the instruction begins with a start bit when the reset line initially goes low, at a transition 1202, where the function block 812 is active in the normal operating mode, such that the serial data pin is under control of the CPU 811. However, when the next transition 1204 occurs, this occurring before the reset time of the reset detect block 810, this indicates that the serial mode is being initiated. If it were a Reset operation, typically, the time between a negative going transition and a positive going transition must be greater than five or ten μs. However, if it is less than that, then this indicates a start bit. Therefore, the start bit indicates that the possession of the data pin should be directed to the serial interface controller 814 and taken away from the CPU 811 and function block 812. The shaded areas on the data indicate the data line is being driven by either the serial interface circuitry on the integrated circuit 702 or other circuitry on the integrated circuit 702 and non-shaded areas indicate driving by the translator 706. After the transition 1204, the translator 706 will enable its output driver.

In the diagram, the box 1201 indicates that the function block 812 has possession of the pin, whereas the translator 706 tri-states its driver. At edge 1204, the driver associated with translator 706 is enabled, which has some delay associated therewith, resulting in the output of the translator driver being tri-stated, indicated by a state 1103. This is where possession of the pin is transferred or “stolen,” indicated by a time period t_{zv} of approximately 1 to 20 ns. This will result in data being output in a data valid field 1205 for the first command bit at the end of state 1203. This data will then be output by the translator 706 and will be shifted in at the next rising edge, edge 1106, to shift in an instruction bit, a “0” bit, and then another and subsequent data bit will be shifted in at the following and second rising transition 1208 to shift in another instruction bit, a “1” bit. For an AddressRead command, the control word is a “01” that is read by the controller 1032, which controller 1032 is operable to recognize the first two bits shifted in as the appropriate command to determine whether this is a Read or a Write operation. Once it recognizes the first two bits as being a “01,” it then knows to load the contents of the address register into the shift register 1006 and then the data direction will be reversed and the translator 706 will await data transfer from the integrated circuit 702.

In general, when the shift register is clocked on a rising edge, it is preceded by a data setup time period, t_{DS}, of approximately 10 ns and, after the rising edge of the clock, data is held therein for a time, t_{DH}, of approximately 10 ns. After this data hold time for the second command bit received, and during the AddressRead command, the output of the translator will be tri-stated which will require a tri-state setup time, t_{ZS}, of approximately 10 ns to allow the bus direction to be reversed, this occurring on the next rising edge 1210. The LSB of the address register, address bit A0, will be driven out to the multiplexer 1014 and the driver 1015 to the line 1004, which will be sampled by the translator 706. Thereafter, four more rising transitions will be required to complete the AddressRead command of the four bit address, it being noted that there is no stop bit required for a AddressRead command. The device will automatically return the shared data pin to its user-defined state after the last bit of the AddressRead command is completed.

Referring now to FIG. 13, there is illustrated a timing diagram for a device reset. During transmission of serial data instructions, the serial data clock line must not be held low longer than t_{CL}, which has a minimum time of 20 ns and a maximum time of 5000 ns. This requirement allows the device to be reset by holding the serial clock line low for an extended period of time given by t_{RD} which has a minimum value of approximately 10 μs. If a Reset is detected, this will reset all device logic on the integrated circuit 702, including the serial controller interface 814, regardless of the state thereof. After a Reset and once the serial clock line/reset line returns high, at an edge 1302, the serial interface controller 814 will ignore any additional strobes for at least a time period, t_{RB}, of a minimum of 100 ns to a maximum of 1 μs, this being a blanking region illustrated by cross-hatched area 1304. This prevents extra edges on the serial clock line/reset line when releasing the system from reset from initiating an instruction. The start bit of the first instruction after reset must begin at least a time period t_{RD} after reset, which has a minimum time of 2 μs. However, it should be understood that the serial data interface can be operated in any mode wherein a device reset is not required, i.e., any time there is a falling edge and rising edge less than a reset time occurring, wherein this will indicate a start bit and data can be read or written to the serial interface controller 814 and the operation can be “stolen” from the CPU of the data pin. However, for the present disclosure, the serial interface requires knowledge of the state of the integrated circuit before stealing the pins. The instructions are sequentially input in accordance with a state machine running in both the integrated circuit 702 and the translator 706, requiring that the instructions be initiated at a known state, i.e., synchronized. In some situations, the input of data may not require synchronization between two state machine, such as for loading a register with a value. For the synchronous state machine condition, by utilizing a device reset, the state machine of the serial interface controller 814 can be reset to a known state and instructions initiated therefrom, such that both state machines are synchronized.

The serial interface protocol, in the present disclosure, provides four basic instructions named Address write, AddressRead, Data write and Data read. This, therefore, requires a two bit command instruction. Each instruction will be described as a sequence of bits, each sequence shown with the LSB on the right and shaded bits indicated as being driven by the serial interface controller 814 or other circuitry on the integrated circuit 702.

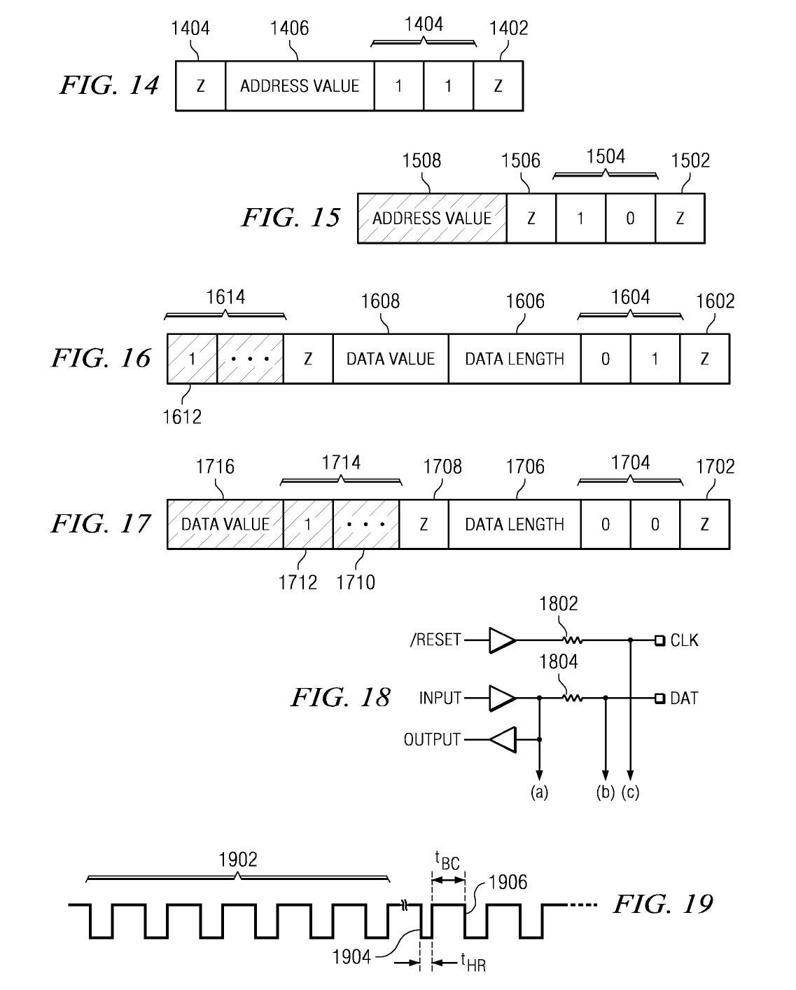

Referring now to FIG. 14, there is illustrated a diagrammatic view of the Address write instruction. This instruction is an instruction that sets the address register to a specified value. This value controls the data register selected for any Data write or Data read instruction until the next Address write instruction or device reset. The Address write instruction consists of an LSB 1402 which is a high-Z bit (generated by the translator 706) followed by two command bits, “11” in a field 1404. As described herein above, these two command bits are read by the controller 1032, indicating that the next sequence of bits, a defined field 1406, will be read as the address value. After this defined field length, a high-Z bit will be present driven by the translator 706, in a field 1404. Again, as noted herein above, the length of the field 1406 must equal the address register length of the address register 1016 for the serial controller interface 814. This was determined from a Read of the device ID register, an 8-bit read-only register, that provides the hardware ID for the serial control interface. The device ID is automatically selected by a device reset and, thus, can be read without any knowledge of any other register sizes in the device. A subsequent Data read command having an 8-bit length will read the contents thereof. Conversely, when an address value determined from reading the device register is input as the address in an Address write command, this will select the revision ID register 1020, with a subsequent Data read command operable to read out the contents of the revision ID register 1020. This therefore allows the device to be initially identified by performing a 1-byte Data read instruction immediately after a device reset to obtain the device ID value. This basically configures the state machine in the translator for subsequent Read/Writes.

Referring now to FIG. 15, there is illustrated a diagrammatic view of the bit sequence for an AddressRead instruction. The first bit in the sequence is a high-Z bit in a field 1502 followed by the command instruction “10” in a field 1504 indicating an AddressRead command. This is followed by a high-Z state in a field 1506 where the bus direction is reversed and then the address value is output, in a field 1508. The length of the address value must equal the address register length for the device.

Referring now to FIG. 16, there is illustrated a diagrammatic view of the bit sequence for a Data write command. In the Data write command, the selected data register is set to a specified value. The Data write instruction, as all instructions are, is initiated with a high-Z start bit 1602 followed by command field 1604 with a bit sequence of “01.” This is then followed by a specified number of bits that define the data length, this being a 2-bit field that specifies the Data value field in bytes −1. The Data length field 1606 is followed by a Data value field 1608 having a length defined by the Data length field 1606. This is then followed by a high-Z bit 1610, which is a bus turnaround state. Thereafter, there is output by the serial control interface 814 a wait state which is a sequence of “0's” followed by a 1-bit 1612. The “0's” are illustrated by a series of “ . . . ” prior to generation of the “1.” This “ . . . ” represents zero or more “0's” transmitted by serial control interface 814. With the use of this wait state, access to slower memories or registers is supported by letting the state machine on the integrated circuit 702 stall an instruction while waiting for an access to be complete. The length of this wait state can be fixed or it can be deterministic, i.e., determined by an internal flag or the such. The wait state removes the need for subsequent instructions in protocols such as JTAG that require handshakes to determine that the receiving device is ready to receive information.

As an example, if the value in the data length field 1606 were equal to “0b00,” (in ANSI-C binary notation) the Data value would be 1 byte long. It is noted that the value of Data length does not necessarily equal the length of the actual data register to be written. For example, if only the 8 MSB's of a 10-bit data register was required to be written, Data length could be set to “0b00” and the Data value in field 1608 would define just the 8 MSB's of the register. The remaining register bits will be written with undefined values. To write to the entire register, Data value must be two bytes long (therefore Data length=“0b01”). In this case, the 10-bit value to write must be left-justified in the 16-bit Data value field. The value of the padding bits is unimportant.

After the Data value and the “Z” bit is transmitted, the serial control interface 814 will provide a wait-state response, wherein the actual write occurs on the last rising edge of the serial clock. In general, the combination of the last “1” bit 1612 and the wait state of “0's” constitutes a field 1614 which is an acknowledgment or “ACK” field that prevents another instruction from being initiated by the state machine in the translator 706. After transmission of the last “1” in the field 1612, the instruction will end.

Referring now to FIG. 17, there is illustrated a diagrammatic view of the bit sequence for the Data read instruction. This instruction returns the selected data register value that was defined by the previous address that was provided in the Address write instruction. The Data read instruction consists of a sequence as initiated with a start bit 1702 as a high-Z bit followed by a command field 1704 of two “0” bits as a field “00.” This is followed by a data length field 1706, which has the same format as in the Data write instruction as described herein above with respect to FIG. 16. As with the Data write instruction, the Data length does not necessarily have to match the length of the selected data register. If only the LSB of the addressed data register need to be read, Data length can be set to fewer bytes than available in the register. After the Data length field has been received, a high-Z state or bit is then received in a field 1708, indicating that the bus is to reverse direction such that data can be transmitted therefrom. Initially, there will be a wait state field 1710 of a plurality of “0's” followed by a “1” in a field 1712, all comprising a wait sequence 1714 to allow the registers to be addressed. After this wait sequence 1714, a Data value field 1716 follows.

When reading a data register whose size is less than Data length, the register read will be right-justified in the Data value field with undefined bits as padding. If Data value is longer than the register Read, the value is right-justified. Note that the data read in the field 1716 is transmitted LSB first immediately after the “1” bit 1712 is transmitted.

The four instructions that were described herein above are of use when programming the serial controller interface 814 and for testing the operation thereof. However, there are other features provided in the serial interface controller 814 to support in-system debugging. These include support for sharing the serial clock and serial data pins with user functions, detecting a halt command in the serial control interface 814 without using the serial data pin, and forcing a serial control interface 814 halt also without utilizing the data pin.

Referring now to FIG. 18, there is illustrated a schematic diagram of circuitry utilized to allow a serial interface with the integrated circuit 702 when in normal operation. When, for example, a debugging operation is required, the IDE software typically communicates with the serial control interface 814 only when it is halted. Since all user software and peripherals are stalled in this state, the serial control interface 814 can temporarily “steal” the serial clock and serial data pins from the application. This is accomplished by providing two external resistors 1802 and 1804 connected to the serial clock pin and the serial data pin, respectively. The other end of the resistors 1802 and 1804 are connected to the reset function pin and the data/input/output function pin, respectively. Upon detecting that the device has entered its halt state, which will be described herein below, the translator 706 then samples the logic level on the side of the resistor 1804 labeled (a) and then drives that same level back onto the node (a). This allows it to then control the serial data at the node labeled (b) and the serial clock at the node (c) without affecting the state of the user's system.

When the system on the chip is released from halt, i.e., all of the registers and software instructions and states that were halted will resume normal operation and the translator 706 will immediately disable its driver on the node (a). The reason for this is that there may be signals on the shared data pin that are driven at one state or the other when the integrated circuit 702 is in the middle of an application. When the node (b) is forced to a different state, this would require an “overdriving” situation. For example, if the input were at a logic “high” at node (a) and it was desirable to pull the node (b) low once the pin has been “stolen” by the translator 706, it might be that the current draw from pulling the node (b) low would effect the driver from the peripheral circuitry that is driving the data pin in normal operation. As such, additional drive current could be added at the node (a) by the translator 706. Once the device goes out of halt, this driver at node (a) from the translator 706 would be removed. In certain situations, as will be described herein below, a request can be made by the serial control interface 814 for the CPU 811 to halt its operation, i.e., suspend operations at their current state. However, until the system is halted, it may not be desirable to steal the operation of the data pin associated with the function block 812 at the multiplexer 902 (although this situation is contemplated in certain “overriding” operations). As such, it would not be desirable to send an instruction which would require data to be input to the associated data pin by the translator 706. Thus, there is provided a way to signal the translator 706 that the system has been halted, such that the shared pin can now be placed in the serial data mode such that data can be transmitted/received from the serial control interface 814. In general, the system may enter its halt state due to an enabled break point, a watch point, or some other on-chip debug feature. The serial control interface 814 monitors for such an event. To facilitate communication of this event, the control block 1032 will output a signal on line 1050 forcing the serial clock line 1040 low, as illustrated in FIG. 10. This is facilitated with the block 1042. In general, the clock drivers are open collector drivers that are operable to pull the clock line low, with some type of pull up device disposed on the line. Therefore, it is only necessary to provide an open collector pull down on the line 1050 to pull the line 1040 low for a preset time. This is a single active-low strobe which is low for approximately 400 ns, thus allowing the serial control interface 814 to provide what is, in effect, an interim source that can be monitored by the translator 706 to detect a halt condition in the device without using the shared data pin, thus allowing the shared data pin to operate in conjunction with the overall chip in operation. The translator 706 must wait at least approximately 1000 ns after the strobe before initiating a serial instruction, this providing an internal blanking period which improves noise immunity.

Referring now to FIG. 19, there is illustrated a timing diagram for the operation of detecting a device halt. In FIG. 19, the clock is illustrated as providing a plurality of clock transitions 1902 that represent an instruction. At a later time, a falling edge 1904 indicates the strobe which is driven by the serial control interface 814, whereas the previous clock cycles in the instruction 1902 are driven by the translator 706. Once this has been detected, a subsequent falling edge 1906 indicates the beginning of an instruction from the translator 706. The serial control interface 814 is designed, such as to accommodate the situation where an instruction is sent to the serial interface controller 814 prior to the acknowledgment being received by the translator 706. Since the pulse width of the active-low strobe at edge 1904 is less than the active-low portion of the serial clock, the serial clock will “swallow” the active-low strobe if there is contention. The serial control interface 814 will recognize that the clock line is still low after it has released the clock line and, as such, will recognize this as a start bit and then will proceed accordingly.

One use of the active-low strobe is to provide an acknowledgment when the system halt has occurred in response to receiving an external signal to force the halt. In this operation, a bit in one of the data registers is written in a previous instruction that constitutes an AutoHalt feature. The AutoHalt feature is a feature that, when enabled, causes the state machine of the serial control interface 814 to monitor the serial clock line and, upon detecting the next rising edge of the serial clock, to automatically set the halt request flag which is output to the CPU 811 and the rest of the system. Typically, when the state machine of the serial control interface 814 is operating, the overall system is at a “halt” mode. When the state machine has finished executing all of the operations associated therewith, it will then release this system from the halt condition. Just prior to releasing the system from the halt condition, the translator 706 would write the AutoHalt bit to the appropriate logic level, typically a “1.” Thereafter, the translator can generate an AutoHalt strobe on the clock/reset line with a clock low time of approximately 3 μs. This will ensure that it will be recognized by the serial control interface 814 even when generated coincident with the active low strobe that may be generated when indicating that the system is to be halted.

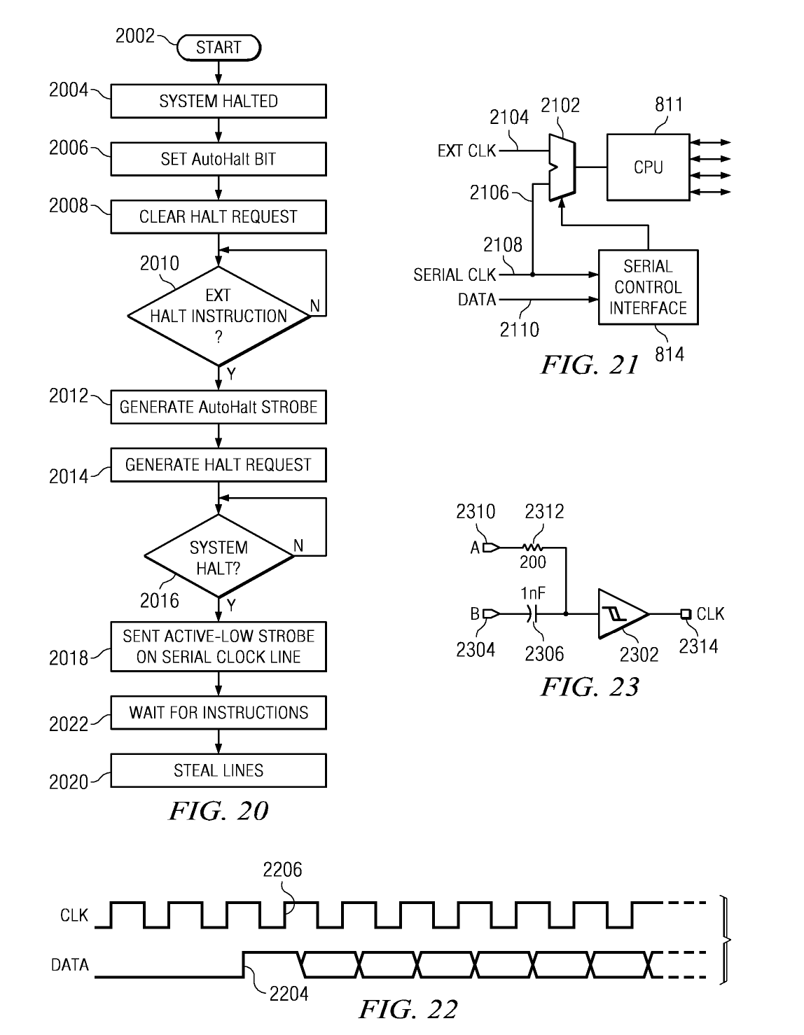

Referring now to FIG. 20, there is illustrated a flowchart depicting the operation for the AutoHalt feature. This is initiated at a Start block 2002 and then proceeds to a function block 2004 to indicate that this system is already in a halted mode, such that the shared data pin is directed toward the serial control interface 814. In this mode, the translator 706 is communicating with the integrated circuit 702 over that shared pin. In this communication, a command embedded within an instruction is sent to set the AutoHalt bit, as indicated by a function block 2006. This program then flows to a function block 2008 wherein a command is sent to the serial control interface 814 to clear the halt request to the CPU 811, it being noted that both of these commands are embedded within the same instruction. The clearing of the halt request flag also then changes the operation such that the shared data pin is now directed toward the function block 812 and the overall operation of the system in the normal application mode. The program then flows to a decision block 2010 to determine if an external halt instruction is required to be generated by the translator 706. If this is case, the program will flow along the “Y” path to a function block 2012 to generate the AutoHalt strobe at the translator 706. The clock line will be pulled low for approximately 3 μs, and the rising edge thereof will cause the serial control interface 814 to generate a halt request, as indicated by a function block 2014. The program will then flow to a decision block 2016 to determine if the system has been halted. Once the system has halted, the CPU 811 or other circuitry in the system will indicate to the serial control interface 814 that a halt condition has occurred. The program will flow along a “Y” path from the decision block 2016 to a function block 2018 to generate the active-low strobe on the serial clock line and then the program flows to function block 2022 wherein the serial control interface 814 waits for instructions to be received from the translator 706. When the start bit of the instruction is received, the program flows to function block 2020 to steal the shared data line such that it is directed toward the serial control interface 814.

In order to guarantee the ability to reset and program an uninitialized device (i.e., a device with random program context), the serial control interface 814 and the overall system on the integrated circuit can be reset regardless of its current state by holding the serial clock line low for the time t_{RD}. As described herein above, the serial clock line driver is an open-drain driver such that it cannot prevent the reset operation. Any logic that is used for debugging or in any way running the state machine of the serial control interface 814 is disabled by the reset operation. This guarantees that a halt request cannot be generated on-chip regardless of the program contents. This prevents any strobing of the clock line by the serial control interface 814. Further, as also described herein above, the reset state of the address register selects a device ID, such that the device can be identified without any knowledge of the device-specific interface features.

Referring now to FIG. 21, there is illustrated a diagrammatic view of another mode of operation. This mode of operation is referred to as the TestMode command. In certain situations, during testing, it is desirable to not have to continually turn on and off the serial clock in order to sequence instructions, it being noted that the serial clock is required to generate the start bit. In the TestMode mode of operation, a single serial clock is utilized for both serial data communication and the operation of the CPU 811 and all circuitry associated therewith. As noted herein above, the serial interface to the integrated circuit 702 and the operation of the integrated circuit 702 are typically asynchronous; that is, a separate clock is provided for the CPU 811 that is not synchronized with the serial clock utilized for serial data communication. To facilitate this, a multiplexing device 2102 is provided that has two inputs, one for receiving an external clock signal on a line 2104 and the other for receiving an input line 2106 that is connected to the serial clock input line, a line 2108. Data for the serial data operation is provided on a line 2110, which line 2110, although not illustrated, is connected to one of the shared pins which would be shared with the operation of the CPU 811. Both the serial clock line 2108 and the data line 2110 are input to the serial control interface 814.

In operation, an instruction would be sent to the serial control interface 814 to enter a mode wherein the multiplexer 2102 would select as the clock input to the integrated circuit 702 the serial clock that is received from the reset pin. It should be understood that the output of the multiplexer 2102 can drive many on chip functions with the clock, this being the main clock for the chip for the integrated circuit 702. However, for the serial data mode as described herein above, the Start bit for each instruction requires a detection of a rising edge on the clock line. In the TestMode mode of operation, the serial control interface 814 enters a mode where the shared data pin is permanently possessed by the serial control interface and the application that is normally running on the integrated circuit 702 is allowed to operate when instructions are not being transmitted, noting that shared data pin is no longer available to the application during TestMode. However, when instructions are to be transmitted, the Start bit comprises the operation of the shared data pin 2110 being high.

Referring now to FIG. 22, there is illustrated a detailed timing diagram of the operation of the data pin and the serial clock pin during the TestMode mode of operation. As noted herein above, during this mode of operation, the serial clock will be continuously running, due to the fact that it provides the master clock to the CPU 811. The data line, however, will be permanently possessed by the serial control interface 814. When an instruction is not being sent, it is not in the serial data mode, and the data pin 2110 will be held low. When the data on the shared data pin is high at 2204, and upon the next rising edge of the clock, an edge 2206, this will constitute a start bit. This will be similar to the sampling operation described herein above with respect to FIGS. 11 and 12. At the end of an operation wherein a Stop bit is required, the data line 2110 is merely held low without the requirement for a tri-state, for example, the end of a Write operation.

Referring now to FIG. 23, there is illustrated a diagrammatic view of a circuit for providing a parallel port interface for device programming, such that the serial clock can be operated from the parallel port of a computer. This is to allow users the ability to program devices for production using custom software rather than the built-in interface software. Working from the parallel port of the computer, it is difficult to ensure maximum high and low times for the clock signal due to the multi-tasking nature of most operating systems. The solution is to provide a one-shot circuit 1702 wherein a low-going strobe will be generated at an input 2304 which is coupled to the input to the one-shot 2302 with a capacitor. A second input 2310 is input to the one-shot 2302 through a series-connected resistor 2312. The output of the one-shot 2302 will generate a low strobe on a line 2314, the clock line, when the node 2304 is changed from a high to a low while node 2310 is high. A device reset can be generated by holding both nodes 2310 and 2304 low. Further, it is possible to perform debugging across the parallel port if the parallel ports interrupt capability (NACK pin) is utilized to detect the strobe that is output on the clock line from the integrated circuit 702 and the serial control interface 814. To support this option, it may be that the length of time that the strobe is active will have to be extended. It is also possible to utilize the Enhanced Parallel Port (EPP) to generate a strobe appropriate for the serial clock rather than the circuit illustrated in FIG. 23.

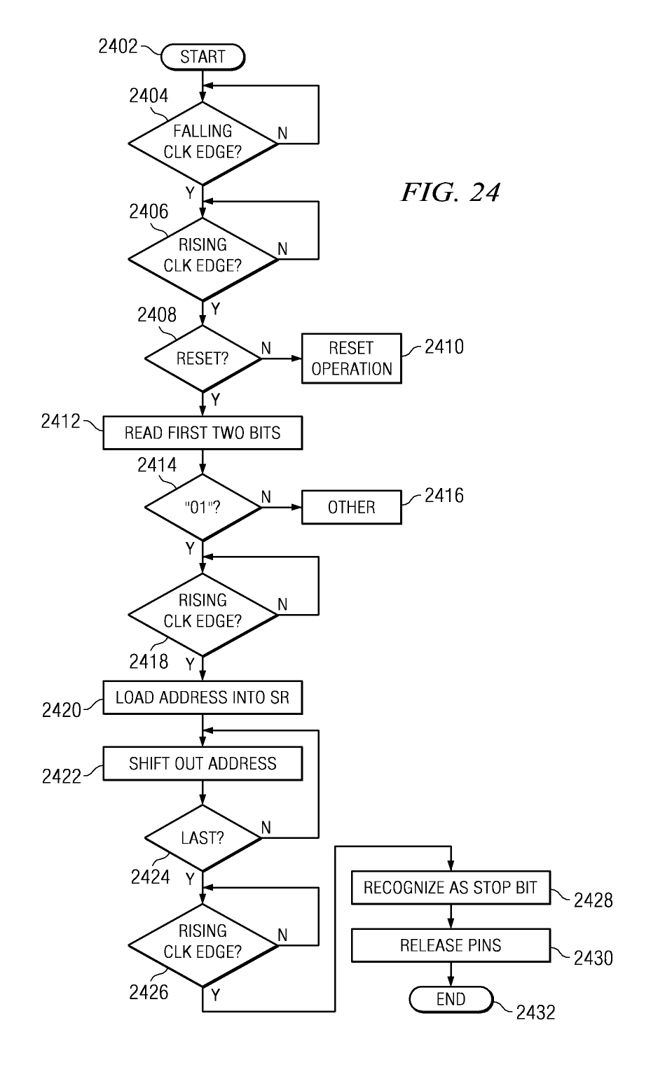

FIG. 24 illustrates a flowchart depicting the operation of the serial control interface 814 for receiving and processing a ReadAddress command. The program is initiated at a block 2402 and then proceeds to a decision block 2404 to await the first falling clock edge on the Reset Pin, this being the serial clock pin also. When the first falling clock edge occurs, this is recognized by the state machine in the serial control interface 814. The serial control interface 814 then awaits the next rising edge, as indicated by a decision block 2406. When the rising clock edge occurs, then a determination must be made as to whether the length of time between the falling edge and the rising edge is less than the reset time, as indicated by decision block 2408. If greater than or equal to the reset time, then the program will proceed along the “N” path to a block 2410 indicating that the reset operation is to take place. However, if it is less than the reset time, this indicates a Start bit for serial data transfer and then the program will proceed along the “Y” path to a function block 2412 wherein the first two bits received will be read. As noted herein above, the controller 1032 is operable to monitor the contents of the shift register 1006 and the first two locations therein. As soon as these first two locations are clocked in, the particular command being generated will be recognized and then the appropriate actions taken. In the case of a ReadAddress, which timing diagram is illustrated in FIG. 12, the next action to be taken by the controller 1032 is to reverse the bus such that data is transmitted and then load the shift register 1006 with the appropriate address bits. Since a known register is being read, it is not necessary to actually send an address for this particular register with the previous instruction as an Address write command. The decision as to what the command constitutes is made at a decision block 2414. If the command is not for the ReadAddress command, the program will proceed along a “N” path to a block 2416 indicating the processing for other commands. However, if it is a ReadAddress command, the program will flow along a “Y” path to a decision block 2418 to await the next rising clock edge. As described herein above, the translator 706 will basically tri-state its output and then go to a Read mode to await data, i.e., it will sample the data line at appropriate times.

When the rising clock edge occurs, the program will flow from the decision block 2418 along a “Y” path to a function block 2420 to load the address from the address register 1016 into the shift register 1006. The program will then flow to a function block 2422, wherein each address bit will be shifted out on subsequent rising edges of the clock, as described herein above with reference to FIG. 12. The program then flows to a decision block 2424 to determine if the last bit has been shifted out. If not, the program then flows along a “N” path back to the input of function block 2422 until the last bit has been shifted out (this being a predetermined number that was determined from a reading of the Deiced register during a previous instruction). Once the last bit has been shifted out, the program flows along a “Y” path to a decision block 2426 to determine if the next rising edge of the clock has occurred. If so, the program will flow along the “Y” path to a function block 2428 to recognize this as the stop bit and then to a function block 2430 to release the pins, i.e., return the pin to the normal operating mode, and then the program flows to an End block 2432.

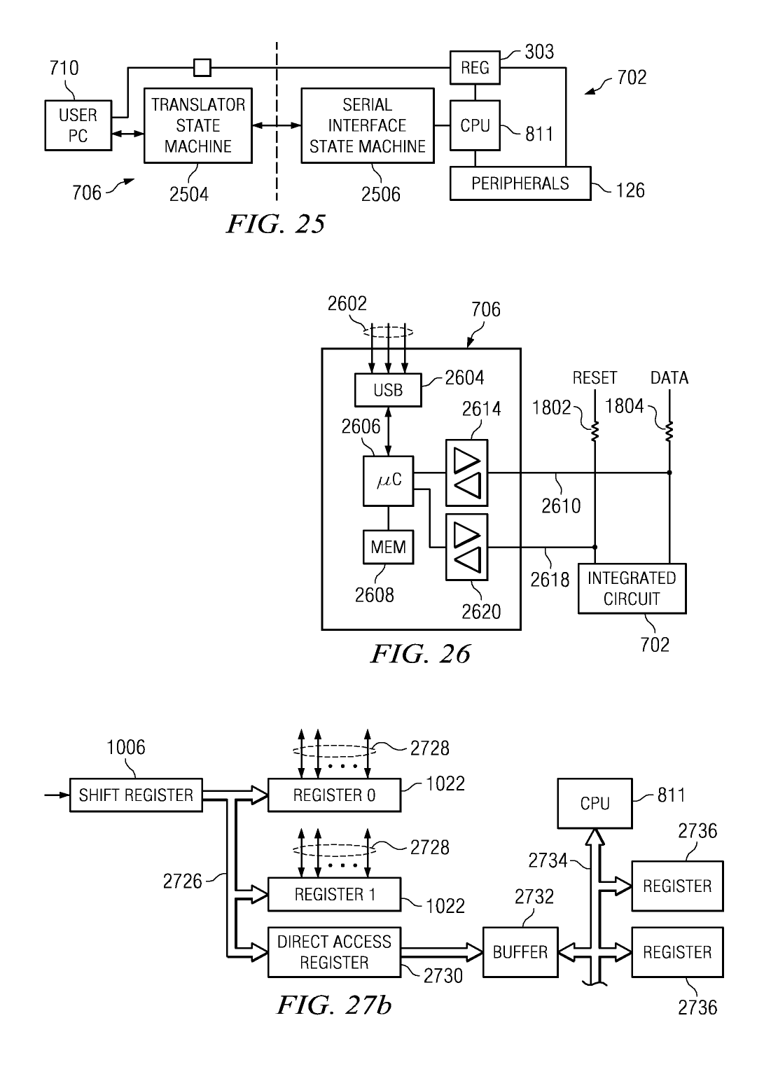

Referring now to FIG. 25, there is illustrated a diagrammatic view of the state machines operating between the translator 706 and the serial control interface 814. There is provided a boundary 2502 indicating the boundary between the integrated circuit 702 and the translator 706. The translator 706 is operable to run a state machine 2504 that receives information from the user PC 710 in its appropriate serial data format and converts this data to the appropriate commands to interface with the integrated circuit 702, which has a serial interface state machine 2506 operating thereon. This serial interface state machine 2506 allows data to be transmitted to the CPU and retrieved therefrom. As noted herein above, the translator state machine 2504 generates its own internal clock and is asynchronous with respect to the user PC 710. Similarly, the serial interface state machine 2506 is asynchronous with respect to the operation of the CPU 811 (assuming this is not the TestMode mode of operation). The translator state machine 2504 generates both the command information embedded within the instructions and also the timing information. The translator state machine will basically generate the starts bits, which will be recognized by the serial interface state machine 2506. This will be followed with the output of command information on the data pin to the serial interface state machine 2506, which state machine 2506 is operable to, upon recognizing a start bit, steal the data pin. Typically, the translator state machine 2504, when sending a start bit, recognizes that the possession of this data pin can be taken by the state machine 2506. The reason for this is that the translator state machine 2504 recognizes that the integrated circuit is in a “known” state. This is due to the fact that a previous reset operation occurred or, alternatively, that a device halt was detected and relayed to the translator state machine 2504 by the serial interface state machine 2506 via the clock line, as described herein above. As such, there are provided two independently operating state machines, of which one state machine receives timing information from the other state machine. However, both machines operate independent of each other.

Referring now to FIG. 26, there is illustrated a diagrammatic view of the translator 706. The translator 706 can incorporate any type of processing device that will receive data from the user PC 710 in the appropriate format, which is illustrated in the present invention as being associated with a USB interface on the serial data/power lines 2602. In one embodiment, the translator 706 is realized with a CS8051 Mixed Signal MCU, manufactured by Silicon Laboratories Inc. Typically, a serial data line will have a data line, a transmit/receive line and a clock line. When data is to be transmitted to the translator 706 from the user's PC, it is synchronously transmitted to the translator 706 and to an RS232 interface 2604. This data will be clocked in and buffered. Similarly, when data is to be transmitted back to the user PC, handshake signals that data is being transmitted from the translator 706 to the user PC 710 is then provided in accordance with the RS232 protocol and data transmitted along the RS232 serial data line. This is a conventional interface. Also, it should also be understood that multiple other serial data interfaces or even parallel interfaces could be utilized to transfer data between the user PC and the translator 706. For example, and I2C protocol could be utilized, a D2B protocol could be utilized, etc.

A microcontroller 2606 is provided which is operable to control the interface 2604 and also run the state machine. A memory 2608 is provided for containing instructions for operating the state machine associated therewith. The microcontroller 2606 is operable to transmit and receive data on a data line 2610 to the shared data input pin of the integrated circuit 702. A transmit/receive circuit 2614 is provided for transmitting and receiving data and buffering the data transmitted between the microcontroller 2606 and the line 2610. Similarly, the clock signal is generated by the microcontroller 2606 on a line 2618 for input to the reset pin input of the integrated circuit 702, as described herein above. Typically, a transmit/receive circuit 2620 is provided, noting that information can be received from the integrated circuit 702 via the line 2618.

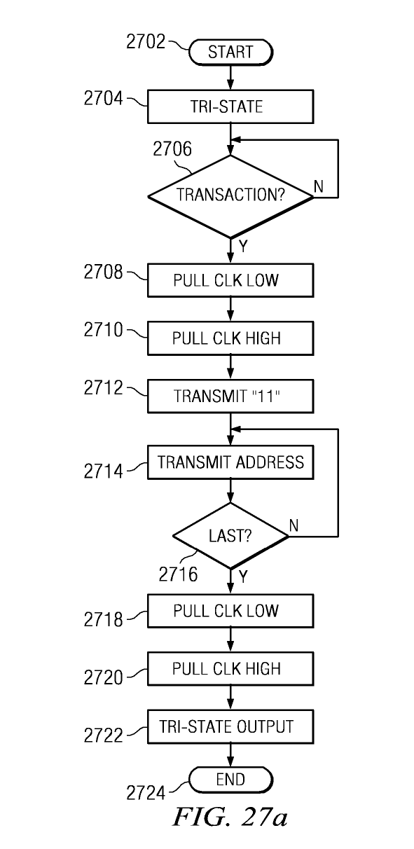

Referring now to FIG. 27a, there is illustrated a flowchart depicting the operation of processing an Address write command in the translator 706, which is initiated at a block 2702 and then proceeds to a function block 2704 wherein it is indicated that the data output of the translator 706 is tri-stated. It is noted, that during this mode, there is no pull down for the reset line. Therefore, the reset line can be pulled low by any other signal. The program then proceeds to a decision block 2706 to determine if a transaction is to be processed, i.e., whether a command is to be sent. If so, the program flows along a “Y” path to a function block 2708 to pull the clock line low and then to a function block 2710 to pull the clock line high before the duration of time indicating a reset. This constitutes a start bit. Upon the next two rising edges of the clock line, the translator 706 will transmit a “11” command indicating an Address write command, as indicated in a function block 2712. The other three commands could also be transmitted for other operations. After transmission of the command, the program flows to a function block 2714 wherein the address bits are sequentially transmitted upon subsequent rising edges. The program then flows to a decision block 2716 to determine if the last address bit has been transmitted. If not, the program will flow back around a path to the input of the function block 2714. Once the last address bit has been transmitted, the program will flow from decision block 2716 along a “Y” path to a function block 2718 to pull the clock line low and then to a function block 2720 to pull the clock line high, this indicating a stop bit. The program then flows to function block 2722 wherein the output is tri-stated and, also, no more low-going clock edges will occur on the clock output 2618. The program flows then to an End block 2724.

Referring now to FIG. 27b, there is illustrated a logic diagram detailing the operation of the registers 1022 and how they interface with the integrated circuit. For simplicity, the shift register 1006 is illustrated as having an output bus 2726 interfacing directly with the data input on the registers 1022. Once addressed, a particular register will have the contents thereof written to or read from. Each of the registers 1022 constitutes a plurality of register locations for interfacing with a plurality of control lines 2728. Each of the control lines 2728 is operable to interface with some function on the integrated circuit, this being a configuration bit or the such. Further, status information can be derived from the integrated circuit and transmitted back to each of the registers for “setting” the bit to the appropriate logic state such that it can later be read.

In order to transfer information to the CPU 811, a separate data register, a direct access data register 2730, is provided. This register 2730 outputs the contents thereof to a buffer 2732, which is basically a synchronization circuit for interfacing the contents of the register 2730 with a data bus 2734 that is associated with the CPU 811. The CPU 811 interfaces with the various registers 2736 and the such on the data bus 2734 for normal operation thereof. The control circuit 1032, when data is to be read or written to the data bus 2734, is operable to write the information in the direct access register 2730 which then, in a conventional manner, will synchronize the operation thereof with the operation on the CPU “address space” by writing information in the buffer 2732 for a Write operation and then setting a flag that will indicate to the CPU 811 that information is in the buffer 2730 to be written to the address space of the CPU 811. For a Read operation, data must be requested from the CPU 811 address space with the appropriate address and then extracted to the direct access register 2730. In general, the direct access register 2730 will occupy some portion of the address space of the CPU 811 and will constitute an addressable location therein. However, the shift register and the serial interface logic associated therewith operates on a different clock than that associated with the CPU 811. Therefore, the buffer 2732, in conjunction with the control circuit 1032, provides a synchronizing function between the CPU 811 and the serial bus interface.

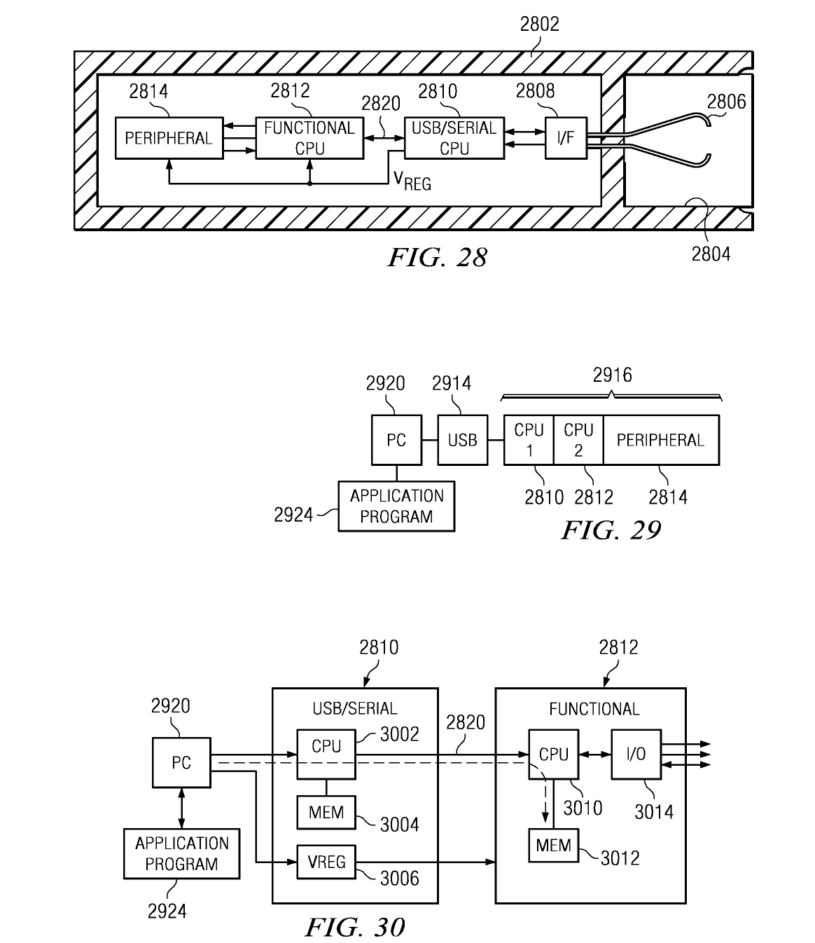

Referring now to FIG. 28, there is illustrated a cross sectional view of the tool stick, which is contained within a package 2802. The package 2802 has a connector housing 2804 associated therewith for interface with a USB connector. There are provided internal to the housing 2804 terminals 2806, as described herein above. The terminals 2806 are connected to an interface block 2808 to provide signal and power outputs to the USB/serial CPU 2810, which is basically the processor module 114 of FIG. 1. As noted herein above, the USB CPU 2810 has disposed thereon an internal voltage regulator which receives the USB power from the USB connector for providing power thereto. However, the output voltage is a regulated voltage for powering a functional CPU 2812, this typically being an MCU with the associated functionality. This functional CPU 2812 provides the nature of the tool stick, i.e. it is the purpose of the tool stick to contain this functional CPU to allow interface thereto from an external PC for running simultaneous thereon. The functional CPU 2818 can operate independently and have nothing attached thereto or it can have a peripheral 2814 associated therewith that is internal for the housing 2802. This peripheral 2814 basically provides the means by which the functional CPU can “test” its outputs. If, for example, the functional CPU 2812 were to be implemented in a motor control application, then it would be expected to drive a motor, sense motor status signals from the motor, motor position signals, etc. and then take certain actions. The peripheral unit 2814, since it is powered by the USB port, cannot run a full sized motor. However, the peripheral unit 2814 could emulate the motor and provide signals thereto. Of course, the peripheral unit 2814 could be as simple as an LED or a piezo transducer for outputting a sound. Even a small voltage generator could be provided to emulate some type of the peripheral unit such that a functional CPU 2812 having a digital-to-analog converter function contained thereon could provide an analog output voltage which could then return an analog input voltage which could then be sensed by an on-chip analog-to-digital converter onboard the functional CPU 2812. The peripheral unit 2814 can provide any type of function that can be utilized for the purpose of “exercising” the function associated with the CPU 2812 for assisting a developer. Data flow is input to the USB/serial bus 2810 in accordance with the normal USB data protocol. However, when the USB/serial CPU communicates with the functional CPU 2812, it is done via a serial bus 2820. This can be a complicated connection or it can be a relatively straightforward, simple connection. One interface to the functional CPU 2812 is that provided with a simple two wire serial data bus that comprises a data line and a clock line referred to as the C2 bus. This has a command structure that can be proprietary in nature for allowing data to be transmitted to the functional CPU 2812 or stored in the memory thereof, for transmitting data to certain of the additional functional registers therein, etc. Also, the JTAG interface can be used to download program information and retrieve data from memory locations on the chip. This C2 bus and the alternative JTAG interface both comprise a bi-directional port, such that program instructions can be downloaded to the functional CPU 2812 and data retrieved for communicating back to the PC. However, typically a program will be developed and then downloaded to the functional CPU 2812 and then that functional CPU 2812 initialized. Thereafter, the operation of that program in the actual device can be monitored, debugged, altered, etc. Data can also be input to various special function registers to configure the various hardware portions of data I/O, as will be described herein below.

Referring now to FIG. 29, there is illustrated a block diagram illustrating the use of the tool stick. The tool stick is utilized in conjunction with a PC 2912 that interfaces to a USB connector 2914 to the tool stick 2916. The tool stick 2916, as noted herein above, is comprised of the USB CPU 2810, the functional CPU 2812 and, alternatively, the peripheral unit 2814. All that is required is that this tool stick 2916 be plugged into the USB connector. The PC 2912 operates with an application program for the general operation of the PC, but the application program is application specific to the tool stick and provides a development tool for debugging, analyzing, etc., the operation of the functional CPU 2812.

Referring now to FIG. 30, there is illustrated a cross sectional diagram of the tool stick illustrating the processes carried on inside of each of the modules therein. The PC 2920 is interfaced with the application program 2924 and interfaces with the USB/serial CPU 2810. This is comprised of, at the heart thereof, a microcontroller or CPU 3002. This, as described herein above, is an 8051 based chip, and flash memory 3004 is provided for storing instructions therein. These instructions are not controlled by the PC 2920 but, rather, this particular chip or module 2810 is configured prior to inserting into the tool stick. It already has its functionality defined. Onboard with this chip is a voltage regulator 3006 which receives power from the USB connector to provide both internal regulated power to the chip and also to provide regulated power out. Of course, this power is limited by, first, the power requirements of the regulator 3006 and, also, by the power limitations of the USB protocol, this typically being 0.5 Amps. The functional module or CPU 2812 has associated therewith a CPU 3010, which is typically an 8051 based architecture. It also has a memory 3012 associated therewith and an input/output block 3014. The functional block 2812 could actually be the block 2810 or any similar type of MCU product manufactured by Silicon Laboratories, Inc. (Of course, the other manufacturers' devices need to be interfaced, or even other manufacturers' systems on a chip (SOC) with the serial data port of the USB/serial CPU).

The data interface to the CPU 3010 is typically facilitated with a serial data configuration on the serial data bus 2820. This allows data to be transferred to defined locations within the memory structure and within special function registers on the chip 2812. The chip 2812 can be of a type 8051x, in one example, manufactured by Silicon Laboratories, Inc. The operation of this particular chip is described in U.S. patent application Ser. No. 11/096,597, filed Mar. 31, 2005, entitled “DIGITAL PWM CONTROLLER,” which describes in, for example, FIG. 6A thereof, the serial interface C2D and the C2CK clock which is operable to be interfaced through a debug hardware block to the processor. This is a serial interface port for interfacing with the CPU in that chip. This particular chip also provides all the functionality or substantially all the functionality associated with chip 2812 in the form of timers, serial bus interfaces, port controllers, data converters, etc. The contents of this application are incorporated herein by reference in their entirety. It is noted that the C2 interface is a proprietary serial data protocol and is one way to communicate with the chip, but the chip can also receive information in the way of data via the JTAG interface.

In operation, the PC 2920 is operable to be utilized in one program (not described herein) to develop the code for a specific end application designed to be run on the functional CPU block 2812. After the development thereof, the developed program is downloaded the IC that is of the type identical to the functional CPU block 2812. In normal operation, after the developed program is fully developed and debugged, it can then be downloaded to the designated IC on a production basis. However, if the developer desires to debug the compiled code or make minor changes thereto, it is downloaded to the functional CPU block 2812 disposed in the tool stick, where the functional CPU block 2812 can run the application program stored in the memory disposed on-chip therewith. Once stored, initialization will typically occur upon power up of the part, which, since it is powered up, will begin immediately once it is downloaded. The part will then function in the manner that it was programmed to do. Thereafter, the parameters of the chip can be changed, if desired, to determine what happens to the operation of the program once such things as certain parameters of the timers during actual operation of the program in the functional CPU block 2812 are changed, certain parameters of the serial bus interfaces are changed, ports are reoriented, etc. These parameters are quite extensive and each of these can be manipulated by the PC and the evaluation program just by loading them into Special Function Registers (SFRs) in the functional CPU block 2812. Further, in the debug mode of operation, the program can be stopped at certain positions therein during actual operation of the program in the functional CPU block 2812 and certain values in the program can be temporarily changed to determine what happens. If, for example, all that was required was to blink an LED, the rate of blinking the LED can be changed by merely going into the debug program and changing the timing parameter in the program in a defined SFR or in the memory by changing an instruction.

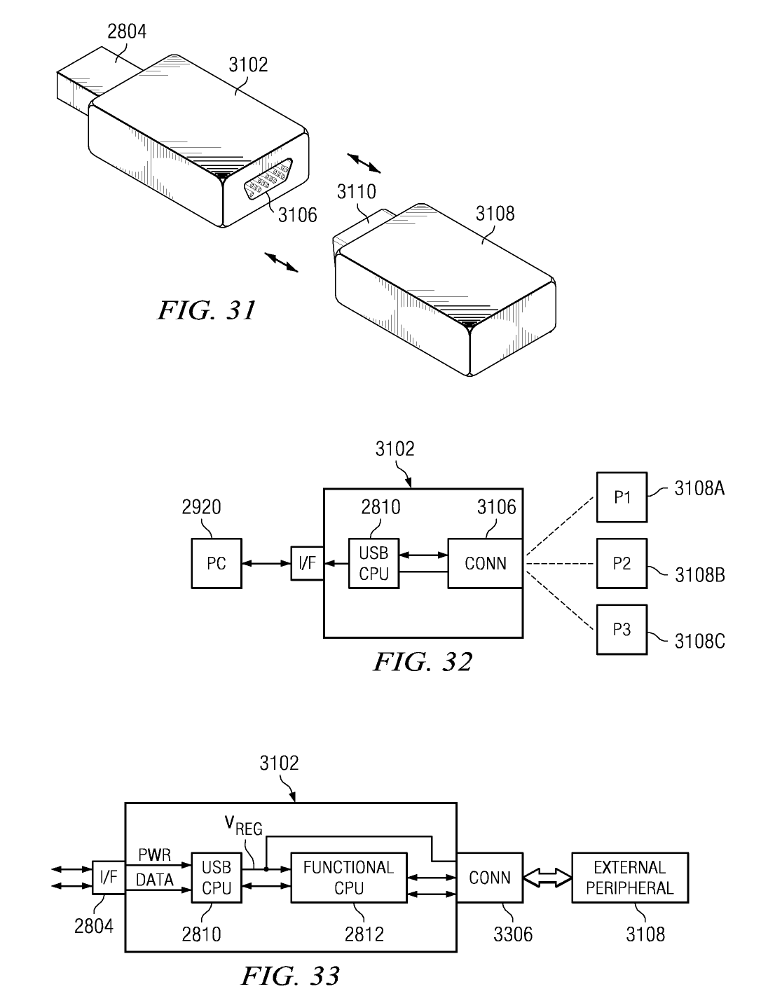

Referring now to FIG. 31, there is illustrated a perspective view of a tool stick and housing illustrating a removable functional module. There is a first part of the housing 3102 that includes the USB connector in the housing 2804. The housing 3102 has a connector 3106 associated with one end thereof that interfaces with the USB/serial CPU chip 2810 (not shown). A second housing 3108 houses the functional modules and, alternatively in conjunction therewith, a peripheral module, and is connectably interfaceable to the module 3102 with a mating connector 3110. In this manner, the USB/serial CPU 2810 can be utilized to interface with multiple different functional modules. Further, each of the functional modules could contain the same part number to be analyzed, but with different peripheral units associated therewith. One, for example, may have the same functional chip to be analyzed with an LED, whereas the other one may have a piezo electric transducer associated therewith and the same functional chip.

Referring now to FIG. 32, there is illustrated an alternate embodiment of FIG. 31. In this embodiment, the housing 3102 contains both USB serial module 2810 and the functional CPU block 2812. However, the connector 3106 is operable to interface with an external peripheral that interfaces with the functional CPU. This functional peripheral is powered through the connector 3106 by the regulator voltage output by the USB CPU 2010.

Referring now to FIG. 33 there is illustrated a diagrammatic view of the embodiment of FIG. 31. In this view, the module 3102 is interfaced with multiple functional blocks in the peripheral modules 3108, illustrated as 3108A, 3108B and 3108C. Each one of these functional modules can have disposed therein completely different functional chips for analysis or a combination of the same functional chip with different peripherals associated therewith. The important thing is that each of these modules houses a functional chip to be analyzed which is a part of the application program in the PC 2920 and that they are powered from the USB CPU 2810.

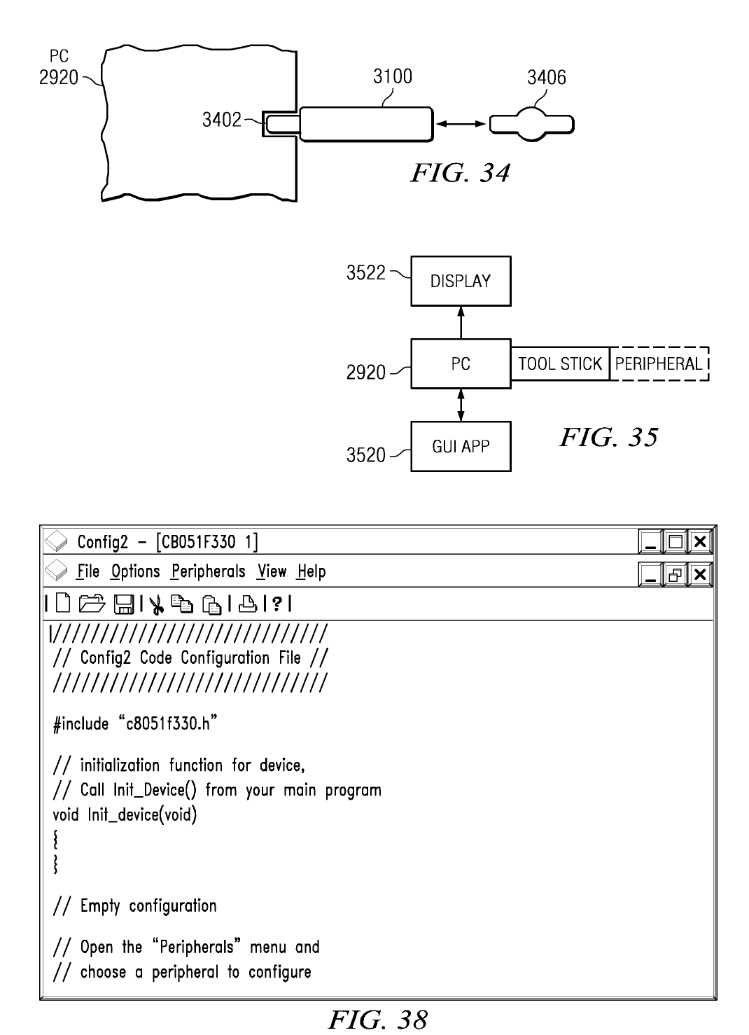

Referring now to FIG. 34, there is illustrated a diagrammatic view of the application utilizing the tool stick of FIG. 33. In this embodiment, the module 3102 is inserted into a USB port 3402 on the PC 2920. This can then be interfaced with an external peripheral 3406, such as a motor. In this embodiment, the motor could be powered externally as opposed to receiving power from the tool stick. However, the functional module 2812 is controlled with the internal program thereto but it can be debugged with the application and GUI in the PC 2920.

Referring now to FIG. 35, there is illustrated a diagrammatic view of the application program and its association with the tool stick. The application program is a GUI (Graphics User Interface) application, as represented by block 3520. The GUI application operates on the PC to provide on a display 3522 various displays and operations. The tool stick is then disposed therein and attached to a peripheral.

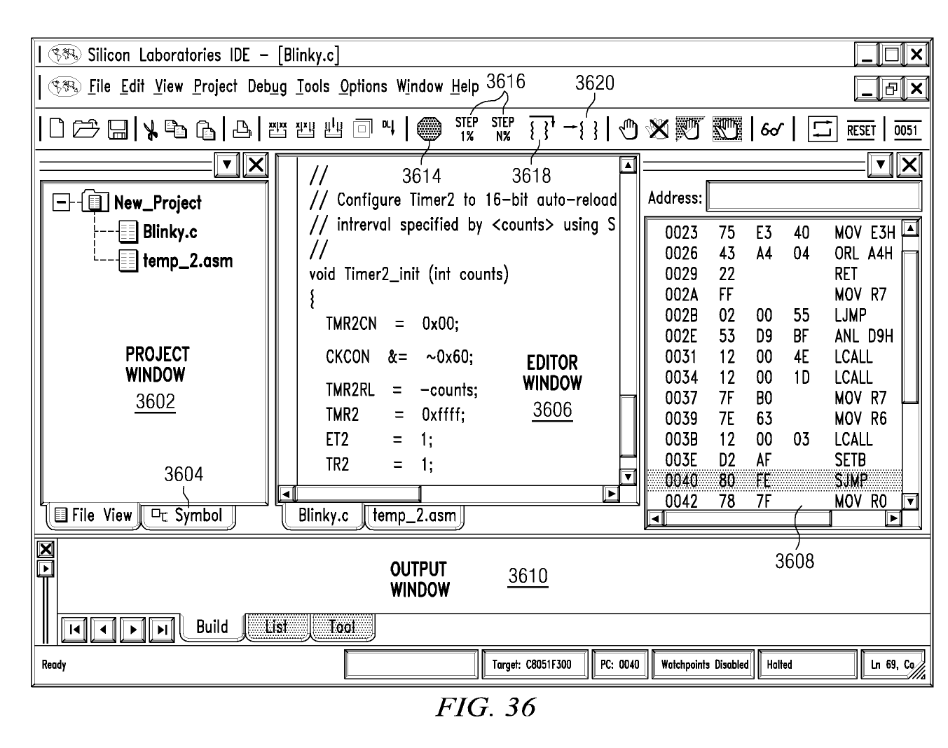

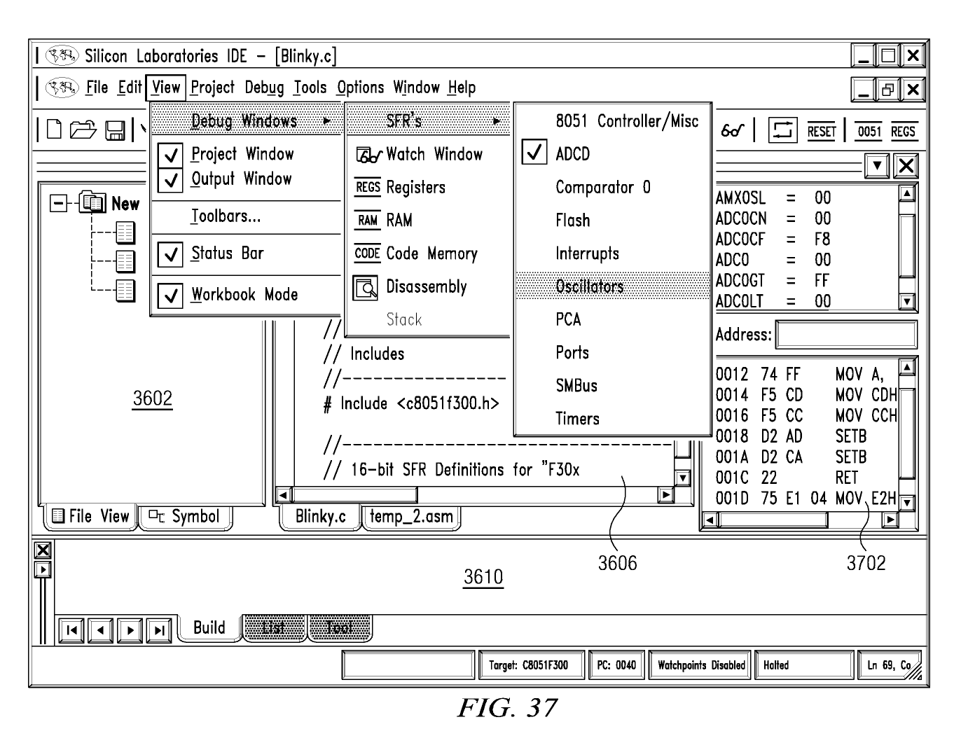

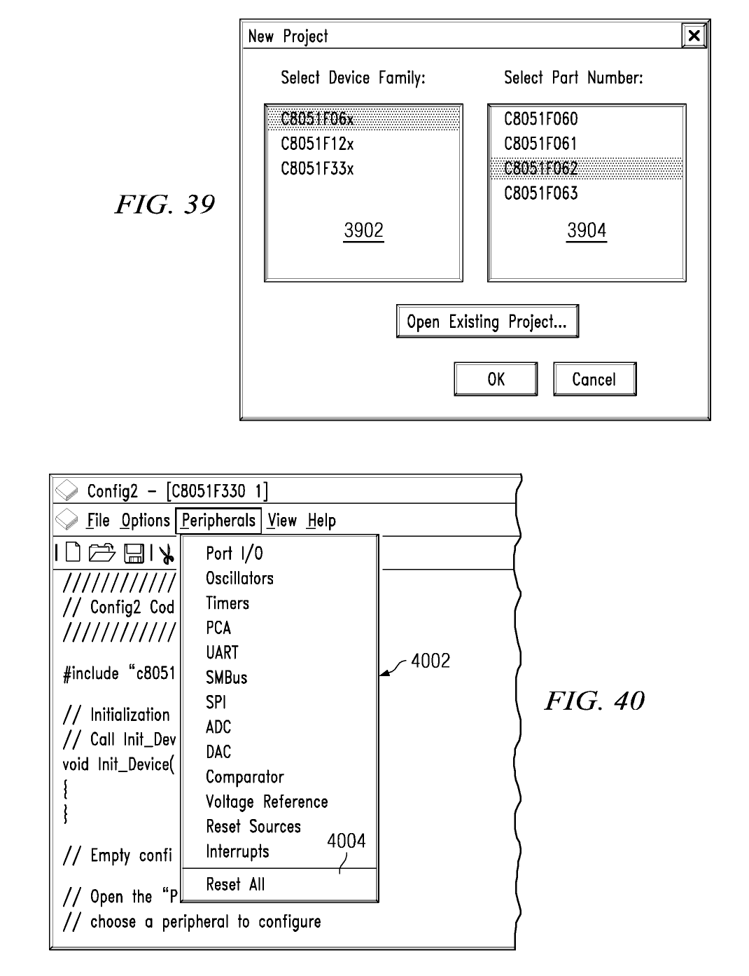

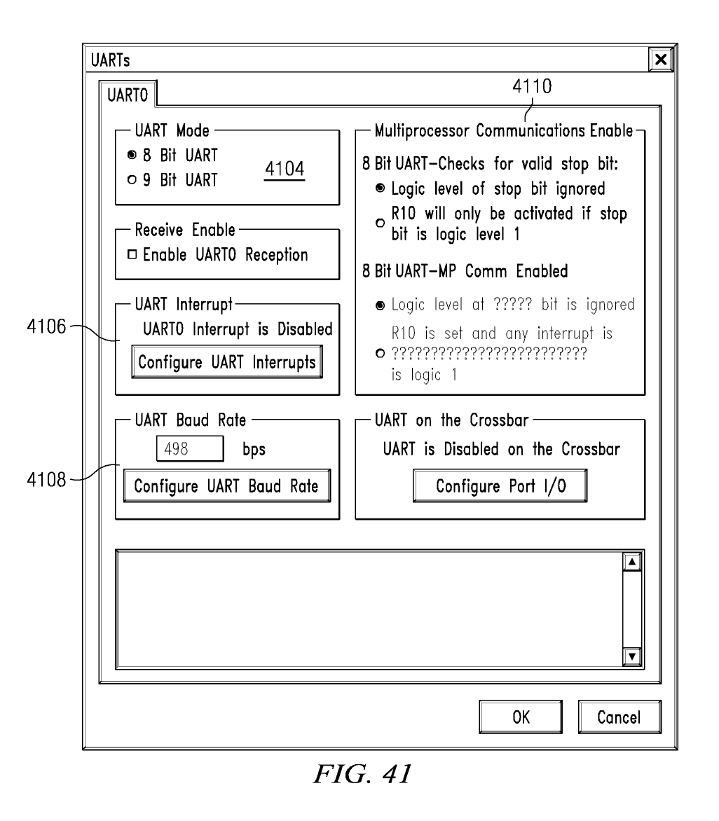

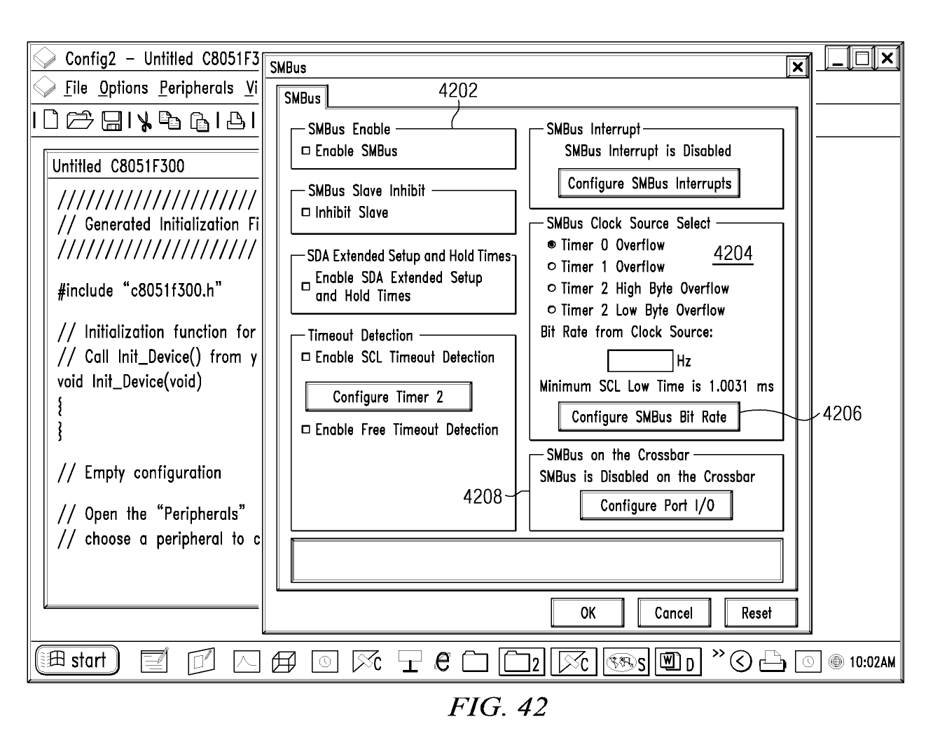

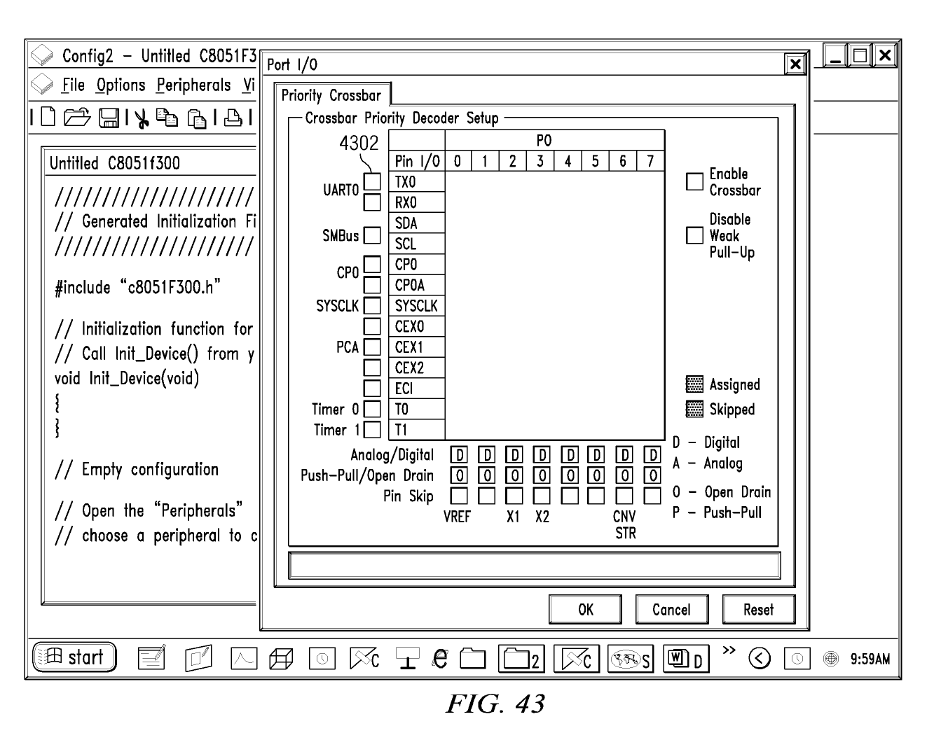

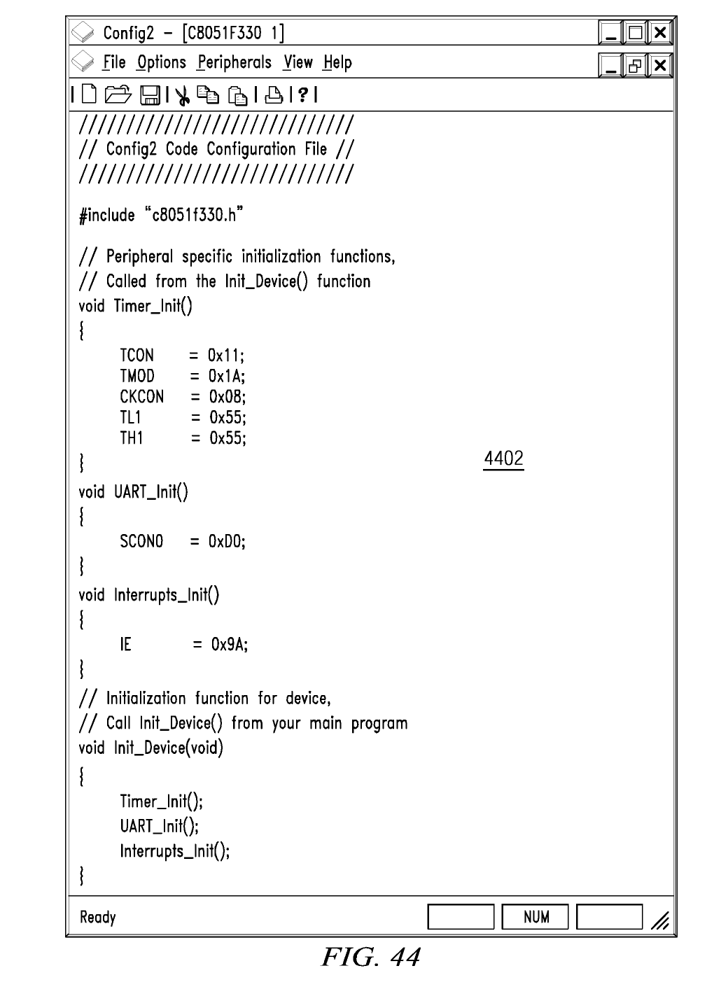

Referring now to FIGS. 36 and 37, there are illustrated screen shots for operating the integrated development environment (IDE) tool. This is a standalone software program that provides the designer with all tools necessary to develop and test their various projects. FIG. 36 illustrates the basic debug window that allows one to view the project. Initially, a project is loaded into the program and then a connection is made to the actual tool stick. Once a connection is made, there is a communication link through the serial interface to the functional CPU 2812. The window illustrated in FIG. 36 shows a project window 3602 which is used to view and manage files associated with a project. A window disposed behind the project window, represented by tab 3604 provides access to a symbol view, which is used to view addresses of symbols used in the project. There is also provided an editor and debug window 3606 that provides a view of the program, when in the debug mode, during operation within the functional CPU block 2812. This basically allows one to stop the program at any place therein to determine the operation thereof. This is basically a status window showing the status of the program and the status of certain registers, etc. The debug window 3608 allows the user to view many windows that provide a view of the operation of various peripherals through the associated special function registers. These are such things as comparators, flash memory, interrupts, oscillators, various ports, the SMBus and the timers. Also, the windows can provide access to other registers, the contents of the RAM, the code memory, and various disassembly aspects. There is also provided an output window 3610 which is used to display information from various processes during development. During the debug routine, there are various buttons associated with the operation thereof to start and stop the program in the functional CPU block 2812, such as a button 3614, various step buttons 3616 to step through the program, and various step over buttons 3618 and a run to cursor button 3620. FIG. 37 illustrates the method by which these various windows can be pulled up and displayed such that the register values associated therewith can be modified. This merely requires positioning the cursor at a register value and then typing the desired value over the existing value. The modified value will then be downloaded to the hardware prior to executing the user application code (via the “go” or “step” buttons). In FIG. 37, there is illustrated one of the registers, a register window 3702 associated with an oscillator. One can go into the oscillator register and set various values and then cause the program to again initiate and then continue on.

Referring now to FIG. 38, there is illustrated a screen shot depicting the Code Configuration Wizard. This allows a user to actually interface with a particular chip. This requires the software to have the information regarding each chip that could possibly be disposed within the tool stick. The screen shot of FIG. 38 illustrates the main window that consists of read-only text that represents the current configuration file. Initially, this file contains a blank function, since a new project sets all registers in the functional CPU block 2812 to their default values. As the values of the registers are changed via a Peripheral menu, changes in the functions for each peripheral will be illustrated in the main window illustrated in FIG. 38.

Referring now to FIG. 39, there is illustrated a new project window wherein one side of the window, the device window 3902, is illustrated containing the different device families that are available in the software. In this embodiment, there are illustrated three different device families, a C8051F0x, C8051F2x and C8051F33x. If the first class, C8051F0x, is selected, then in a right side window 3904, there are displayed the part numbers that are in that particular family. Again, there could be more part numbers in the family, but these are the only part numbers for which the particular registers are defined. The difference between parts may be small. For example, the only difference may be that one has a larger memory than the other. However, some parts will have less I/O peripherals associated therewith, and one chip may only be provided an analog-to-digital converter and not a digital-to-analog converter, and one may have both. Thus, the way the user would interact with a particular device for configuring the settings of these various peripherals, etc., will change. All that is necessary is to select the device family that the user desires to configure in the left box 3902 and then select the specific part for which a configuration is desired in the part number box 3904. Once this is done, a blank configuration file will open. This is illustrated in FIG. 38. This file contains the “#include” for the header of the part specified in an “Init_device( )” function. When the document is opened, peripherals in the functional chip can then be edited, i.e., the parameters associated therewith in the various and associated special function registers can be defined.

Referring now to FIG. 40, there is illustrated the peripheral editing window. To edit a peripheral, a menu list 4002 is “pulled down” to show the various selections. It can be seen that all the peripherals that are associated with this particular selected chip are set forth. In this illustration, the port I/O configuration can be selected, the oscillator peripheral can be selected, the timer peripheral can be selected, the PCA peripheral can be selected, the UART peripheral can be selected, the SMBus peripheral can be selected, the Serial Port Interface (SBI) can be selected, the ADC or DAC peripherals can be selected, the Comparator peripheral can be selected, the Voltage Reference peripheral can be selected, or the Interrupt peripheral can be selected. Further, there is a selection 4004 that allows one to reset all of the peripherals to the predetermined configuration.

Once a peripheral has been selected from the menu, a dialog box, as illustrated in FIG. 41, will be displayed. This particular one is for the UART peripheral. In this embodiment, and in this particular device selected, there is only a single UART associated with the chip. If multiple UARTs were disposed on the chip, there would be tabs for each. In this one, there is only a single one. It can be seen that there are multiple selection windows, such as a mode selection window for 104 that allows the bit value of the UART to be selected. There are also provided an interrupt parameter box 4106 that has a button for selecting all of the configurations for the interrupts. The baud rate can be selected in box 4108 and the manner in which the UART interfaces with the CPU can also be selected in a box 4110. It can be seen that any configuration for the UART that is provided on the chip, i.e., the hardware design configuration aspect thereof, can be provided with selection boxes. All that is required is a special function register somewhere in the chip that defines the manner in which a particular chip operates. For example, if an oscillator were selected, it could be that there is a divider provided with the oscillator to change the frequency thereof. This divider could be selected. Further, in the oscillators associated with some of these particular functional CPU blocks 2812, multiple oscillators are accommodated and multiplexers are provided on-chip for the selection of a particular oscillator. This would be provided in the particular peripheral window associated therewith.

Referring now to FIG. 42, there is illustrated a peripheral window for the serial bus known as the “SMBus.” This is the System Management Bus. This is a conventional bus that utilizes a serial data protocol known in the industry as the I₂C bus. It is a conventional bus utilizing a data line and a clock line, in addition to a ground port. With this peripheral window, there is the ability to actually enable the feature, in a box 4202. The various timer overflow aspects associated with the clock source select for the SMBus is provided in the window 4204 and the bit rate thereof is selectable with a button 4206 that pulls up another window. There is internal to the functional chip a cross-bar switch (not shown) that allows the SMBus functional block within the functional CPU block 2812 to be selected and directed to any port on the output thereof. This is provided by the block 4208 that pulls off the port I/O peripheral configuration panel.

Referring now to FIG. 43, there is illustrated a peripheral window associated with configuring the port I/O. This can be selected from the peripheral menu or it could be selected from, for example, the box 2408 associated with the SMBus peripheral window. In the peripheral window of FIG. 43, the various functionalities (peripherals) that are associated with the chip can be selected in a set of boxes 4302. For example, by selecting the two boxes 4302 associated with the UART zero function, the first two pins of the output are associated with the transmit and receive functions of the UART. If the UART is not selected, then the first two pins could be selected for the SMBus function. If the UART and SMBus functions were selected, the first two pins would be associated with the TX and the RX functions of the UART and the next two pins are associated with the SMBus. This is what is referred to as a priority crossbar switch. The output of a functional block can be associated with the various digital output ports. A diagrammatic view is illustrated that, once selected, would put a “X” in a particular box showing that this was selected. Further, a port can be defined as being digital or analog, if desired, such that an analog signal can be received thereon.

Referring now to FIG. 44, there is illustrated a final configuration window 4402 that illustrates the function of a particular peripheral in the source file. This illustrates the source file after configuring the port I/O, SMBus and timer peripherals. Once the peripheral is configured the way that the developer desires, then they are ready to save the source code to a file.

Although the preferred embodiment has been described in detail, it should be understood that various changes, substitutions and alterations can be made therein without departing from the spirit and scope of the invention as defined by the appended claims.

What is claimed is:

1. A development system to allow a developer to interface a computer running development software that compiles application code for a specific functional integrated circuit that will operate in a predetermined end application with the actual hardware functional integrated circuit having the function of operating with the compiled code so as to allow the developer to operate the compiled code in the actual hardware functional circuit for evaluation purposes, comprising:
a connector for interfacing with a powered data port on the computer that has associated therewith a predetermined data port protocol;
a translation circuit powered by the powered data port and operable to:
translate said data port protocol to and from a tool protocol for output/input therefrom on a translated data output to allow data transmitted to said translation circuit in said data port protocol to be output in said tool protocol and data received in said tool protocol to be transmitted to said connector in said data port protocol, and
level translate the voltage to said translation circuit to a different voltage level;
a functional integrated circuit having associated therewith a processing unit for executing stored instructions, memory for storing instructions and parameters and configurable hardware data input/output (I/O) modules for interfacing between said processing unit and external to said functional integrated, wherein said stored parameters are selectively associated with respective ones of said I/O modules and define the configuration thereof, said functional integrated circuit in communication with said translation circuit through said translated data output; and
a graphical user interface (GUI) operating on the computer to present to the developer viewable selections for interfacing with said functional interface circuit to download compiled code and parameters thereto and cause said functional integrated circuit to run said downloaded compiled code and to allow the developer to alter the stored parameters.

2. The system of claim 1, wherein said translator can provide different levels of output voltage to said functional integrated circuit.

3. The system of claim 1, wherein the connector is a USB connector that provides power therefrom and the data port protocol comprises a USB data protocol.

4. The system of claim 3, wherein said translation circuit comprises an integrated circuit for receiving data in a USB data protocol and converting it to a format compatible with transmission to said functional integrated circuit in accordance with said tool protocol and for receiving data in accordance with said tool protocol and converting it to a format compatible with transmission to said connector in accordance with said USB format.

5. The system of claim 1, and further comprising a peripheral unit interfaced to data I/O ports on said functional integrated circuit to allow transmission of data thereto or receipt of data therefrom.

6. The system of claim 5, wherein said peripheral system emulates at least a portion of the environment in which said functional integrated circuit will operate in when operating in the predetermined end application.

7. The system of claim 1, wherein said GUI further presents to the developer viewable selections to debug the operation of the downloaded developed program when operating on said functional integrated circuit.

8. The system of claim 1, and further comprising a housing for containing said connector, said translation device and said functional integrated circuit.

9. The system of claim 8, wherein said housing is comprised of first and second housings, said first housing contains said connector and said translation device and said second housing contains said functional integrated circuit, and further comprising an interface connector for selectively interfacing the output of said translation device to the input of said functional integrated circuit in accordance with the tool stick protocol.

10. A development system operating on a computer for evaluating compiled program code that was developed to run on a specific processor based functional IC having associated therewith memory and configurable data I/O modules, and which code defines the manner by which the functional IC will operate in a predetermined end application, comprising:
an evaluation program operable to run on the computer;
a tool stick interfaceable with the computer and including a functional IC hat is substantially operationally identical to the functional IC for which the compiled program code was compiled to run on;
said evaluation program operable to interface with said tool stick to load said code in said functional IC associated with said tool stick and operable therewith such that said functional IC in said tool stick functions as a hardware emulator for the end application, such that the compiled code can be operated in hardware.

11. The system of claim 10, wherein said tool stick is operable to interface with the computer through a data port with a predetermined computer interface data port protocol.

12. The system of claim 11, wherein said predefined data port is a powered data port and said tool stick comprises:
a connector for interfacing with said powered data port on the computer;
a translation circuit powered by the powered data port and operable to:
translate the data port protocol to and from a tool protocol for output/input therefrom to allow data transmitted to said translation circuit in said data port protocol to be output in said tool protocol and data received in said tool protocol to be transmitted to said connector in said data port protocol, and
level translate the voltage to said translation circuit to a different voltage level; and
said functional integrated circuit interfaced to said translated data output and having associated therewith a processing unit for executing stored instructions, memory for storing instructions and parameters and configurable hardware data input/output (I/O) modules for interfacing between said processing unit and external to said functional integrated circuit, wherein said stored parameters are selectively associated with respective ones of said I/O modules and define the configuration thereof.

13. The system of claim 11, wherein said translation circuit can provide different levels of output voltage to said functional integrated circuit.

14. The system of claim 11, wherein the connector is a USB connector that provides power therefrom and the data port protocol comprises a USB data protocol.

15. The system of claim 13, wherein said translation circuit comprises an integrated circuit for receiving data in a USB data protocol and converting it to a format compatible with transmission to said functional integrated circuit in accordance with said tool protocol and for receiving data in accordance with said tool protocol and converting it to a format compatible with transmission to said connector in accordance with said USB format.

16. The system of claim 11, and further comprising a peripheral unit interfaced to data I/O ports on said functional integrated circuit to allow transmission of data thereto or receipt of data therefrom.

17. The system of claim 15, wherein said peripheral system emulates at least a portion of the environment in which said functional integrated circuit will operate in when operating in the predetermined end application.

18. The system of claim 11, wherein said tool stick comprises a two part housing including a first connector housing for containing said connector and said translation circuit and a second housing containing said functional integrated circuit;
said first housing having a first interface connector for interfacing with said translated data output of said translation circuit;
said second housing having a second interface connector operable to be mated with said first interface connector and in data communication with said functional integrated circuit; and
wherein, when said first housing is connected to said second housing, data communication between said translation circuit and said functional integrated circuit can be effected.

19. The system of claim 10, wherein the computer includes a graphical user interface (GUI) operating on the computer to present to a developer viewable selections for interfacing with said functional interface circuit to download compiled code and parameters thereto and cause said functional integrated circuit to run said downloaded compiled code to allow the developer to alter the stored parameters, which said stored parameters allow the data I/O modules to be configured.
